(19) United States
(12) Patent Application Publication
(10) Pub. No.: US 2003/0149975 A1
(43) Pub. Date: Aug. 7, 2003

(54) Targeted advertising in on demand programming

(76) Inventors: Charles Eldering, Doylestown, PA (US); John A. Schlack, Southampton, PA (US); Michael A. Plotnick, Southampton, PA (US); Robert F. Deitrich, Doylestown, PA (US)

Correspondence Address: EXPANSE NETWORKS, INC., 6206 KELLERS CHURCH ROAD, PIPERSVILLE, PA, 18947, US

(21) Appl. No.: 10/068,771

(22) Filed: Feb. 5, 2002

(51) Int. Cl. H04N 7/025; H04N 7/10; G06F 3/00; H04N 5/445; G06F 13/00; H04N 7/173

(52) U.S. Cl. 725/34; 725/35; 725/46; 725/87

(57) ABSTRACT

Selecting targeted advertisements to be presented to subscribers along with selected video in a video on demand (VoD) system. The targeted advertisements may be selected based on viewing characteristics, presence or absence of specific transactions, demographics, video selection, or some combination thereof. The selection of the ads may be performed by the set top box (STB) or by the VoD system. If the selection of the targeted ads is based at least in some part based on viewing characteristics, the STB will determine the characteristics of the subscriber by comparing the subscriber interactions to previously generated subscriber signatures that define subscriber traits over a plurality of viewing sessions. The system may either disable the fast-forwarding and skipping of the targeted ads or may present an alternative ad if the subscriber attempts to fast forward or skip the ad

This application claims priority under 35 U.S.C. §119(e) for Provisional application numbers 60/???,??? (Docket No. T742-00) filed on Jan. 9, 2002 that is herein incorporation by reference in its entirety, but is not admitted to be prior art.

This application is related to all of the Applicants co-pending applications, patents and publications listed below. Each item listed below is herein incorporated by reference in its entirety but is not admitted to be prior art:

U.S. application Ser. No. 09/204,888, filed on Dec. 3, 1998 entitled “Subscriber Characterization System” (Docket No. T702-00);

PCT Application PCT/US99/28528 (WIPO Publication WO 00/33160A3), filed on Dec. 2, 1999 entitled “Subscriber Characterization and Advertisement Monitoring System” (Docket No. T702-00PCT);

U.S. patent application Ser. No. 09/516,983, filed on Mar. 1, 2000 entitled “Subscriber Characterization with Filters” (Docket No. T702-02);

U.S. patent application Ser. No. 09/591,577, filed on Jun. 9, 2000 entitled “Privacy-Protected Advertising System” (Docket No. T702-03);

U.S. patent application Ser. No. 09/635,252, filed on Aug. 9, 2000 entitled “Subscriber Characterization Based on Electronic Program Guide Data” (Docket No. T702-04);

U.S. patent application Ser. No. 09/857,256 filed on Dec. 2, 1999 entitled “Subscriber Characterization and Advertisement Monitoring System” (Docket No. T702-15);

U.S. application Ser. No. 09/205,653, filed on Dec. 3, 1998 entitled “Client-Server Based Subscriber Characterization System” (Docket No. T703-00);

U.S. application Ser. No. 09/205,119, filed on Dec. 3, 1998 entitled “Advertisement Monitoring System” (Docket No. T704-00);

U.S. application Ser. No. 09/516,314, filed on Mar. 1, 2000 entitled “Advertisement Monitoring and Feedback System” (Docket No. T704-01);

PCT Application PCT/US01/06459 (WIPO Publication WO 01/65747A1), filed on Mar. 1, 2001 entitled “Advertisement Monitoring and Feedback System” (Docket No. T704-01PCT);

U.S. application Ser. No. 09/452,893, filed on Dec. 2, 1999 entitled “Subscriber Identification System” (Docket No. T705-01);

PCT Application PCT/US99/28600 (WIPO Publication WO 00/33233), filed on Dec. 2, 1999 entitled “Subscriber Identification System” (Docket No. T705-01PCT);

U.S. patent application Ser. No. 09/635,253 filed on Aug. 9, 2000 entitled “Subscriber Identification Based on Electronic Program Guide Data” (Docket No. T705-02);

U.S. application Ser. No. 09/857,160, filed on Dec. 2, 1999 entitled “Subscriber Identification System” (Docket No. T705-13);

U.S. patent application Ser. No. 09/635,253, filed on Aug. 9, 2000 entitled “Subscriber Identification Based on Electronic Program Guide Data” (Docket No. T705-02);

U.S. Pat. No. 6,298,248 issued on Oct. 2, 2001 entitled “Consumer Profiling System” (Docket No. T706-00);

PCT Application PCT/US99/28628 (WIPO Publication WO 00/33228), filed on Dec. 2, 1999 entitled “Consumer Profiling and Advertisement Selection System” (Docket No. T706-00PCT)

U.S. patent application Ser. No. 09/807,887 filed on Dec. 2, 1999 entitled “Consumer Profiling and Advertisement Selection System” (Docket No. T706-11);

U.S. Pat. No. 6,216,129 issued on Apr. 10, 2001 entitled “Advertisement Selection System Supporting Discretionary Target Market Characteristics” (Docket No. T707-00);

U.S. patent application Ser. No. 09/774,473 filed on Jan. 31, 2001 entitled “Advertisement Selection System Supporting Discretionary Target Market Characteristics” (Docket No. T707-11);

U.S. patent application Ser. No. 09/796,339, filed on Feb. 28, 2001 entitled “Privacy-Protected Targeting System” (Docket No. T715-10);

PCT Application PCT/US01/06650 (WIPO Publication WO 01/65453A1), filed on Feb. 28, 2001 entitled “Privacy-Protected Targeting System” (Docket No. T715-10PCT);

U.S. patent application Ser. No. 09/635,542, filed on Aug. 10, 2000 entitled “Grouping Subscribers Based on Demographic Data” (Docket No. T719-00);

U.S. patent application Ser. No. 09/712,790 filed on Nov. 14, 2000 entitled “Queue Based Advertisement Scheduling and Sales” (Docket No. T721-10);

PCT Application PCT/US01/27217, filed on Aug. 31, 2001 entitled “Targeted Advertising at the Set-Top Box” (Docket No. T721-10PCT);

U.S. patent application Ser. No. 09/748,949 filed on Dec. 27, 2000 entitled “Advertisement Filtering and Storage for Targeted Advertisement Systems” (Docket No. T721-13);

U.S. patent application Ser. No. 09/742,527 filed on Dec. 21, 2000 entitled “System and Method for Automatically Managing Avail Inventory Data and Avail Pricing” (Docket No. T721-14);

U.S. patent application Ser. No. 09/748,943 filed on Dec. 27, 2000 entitled “Delivering Targeted Advertisements to the Set-Top Box” (Docket No. T721-17);

U.S. patent application Ser. No. 09/742,534 filed on Dec. 21, 2000 entitled “Queue Based Head-End Advertisement Scheduling Method and Apparatus” (Docket No. T721-18);

U.S. patent application Ser. No. 09/742,852 filed on Dec. 21, 2000 entitled “System for Rescheduling and Inserting Advertisements” (Docket No. T721-19);

U.S. patent application Ser. No. 09/766,004 filed on Jan. 19, 2001 entitled “System and Method for Delivering Statistically Scheduled Advertisements” (Docket No. T721-21);

U.S. patent application Ser. No. 09/658,204 filed on Sep. 8, 2000 entitled “Targeted Advertising Through Electronic Program Guide” (Docket No. T723-00);

U.S. Provisional Application No. 60/238,059, filed on Oct. 5, 2000 entitled “Platform Independent Addressable Television Advertising System” (Atty. Docket No. T726-00);

U.S. Provisional Application No. 60/238,056, filed on Oct. 5, 2000 entitled “Method and System for Addressable Advertising in the Electronic Program Guide” (Atty. Docket No. T727-00);

U.S. patent application Ser. No. 09/749,255 filed on Dec. 27, 2000 entitled “Scheduling and Linking IPG Ads in Conjunction with Programming Ads in a Television Environment” (Docket No. T727-10);

PCT Application PCT/US01/31682, filed on Oct. 5, 2001 entitled “Targeting Ads on IPG's Live Programming and Recorded Programming, and Coordinating the Ads therebetween” (Docket No. T727-10PCT)

U.S. patent application Ser. No. 09/680,622 filed on Oct. 6, 2000 entitled “Method and System for Addressable and Program Independent Advertising During Recorded Programs” (Docket No. T728-10);

U.S. Provisional Application No. 60/260,946 filed on Jan. 11, 2001 entitled “Viewer Profiling Within a Set-Top Box” (Docket No. T734-00);

U.S. patent application Ser. No. unknown filed on Oct. 31, 2001 entitled “Profiling and Identification of Television Viewers” (Docket No. T734-10);

U.S. Provisional Application No. 60/263,095 filed on Jan. 19, 2001 entitled “Session Based Profiling In A Television Viewing Enviromnent” (Docket No. T735-00);

U.S. Provisional Application No. 60/278,612, filed on Mar. 26, 2001 entitled “Formation and Utilization of Cable Microzones” (Docket No. T737-00);

U.S. Provisional Application No. 60/281,037 filed on Apr. 3, 2001 entitled “Personal Video Recorder (PVR) Market Overview And Advertising Opportunities” (Docket No. T738-00);

U.S. Provisional Application No. 660/329,992 filed on Oct. 17, 2001 entitled “Personal Video Recorder (PVR) System Requirements and Specification” (Docket No. T738-01);

U.S. patent application Ser. No. (not yet known) filed on Nov. 14, 2001 entitled “Alternative Advertising in Prerecorded Media” (Docket No. T738-10);

U.S. patent application Ser. No. 09/928,024 on Aug. 10, 2001 entitled “Targeting Ads to Subscribers based on Privacy Protected Subscriber Profiles” (Docket No. T741-10); and

PCT Application PCT/US01/25261, filed on Aug. 10, 2001 entitled “Targeting Ads to Subscribers based on Privacy Protected Subscriber Profiles” (Docket No. T741-10PCT).

### BACKGROUND OF THE INVENTION

Video on Demand (VoD) systems provide subscribers with entertainment on demand, both in the form of complete on-demand video as well as Subscription Video on Demand (SVoD) with which subscribers pay a monthly fee for access to on-demand movies and other programming.

Advertising plays a role in some forms of VoD, either as a means of subsidizing the cost of the programming and costs to provide the programming over the VoD network, or simply as a means of advertising to the subscriber before or after receiving the on-demand programming. Advertising in VoD may be for other VoD services or content, or may be unrelated to the content, promoting products and services that are believed to be of interest to the subscriber. Because VoD is customized programming, it offers the opportunity to target ads to households and thus allows targeting of advertisements to the households most likely to be responsive to the advertising. Often the advertising is targeted to the subscribers based on household demographics or based on the video selection. These types of targeted ads to not take full advantage of the customized nature of VoD.

Through the customized nature of VoD it has been possible to direct ads to individual subscribers on VoD systems. Thus, there is a need for methods and systems for placing subscribers into the appropriate groups or “market segments”. Such market segment techniques must protect subscriber privacy and although are intended to identify specific characteristics of the subscribers should not reveal purchase or channel change data.

### SUMMARY OF THE INVENTION

The present invention is related to a method, system, apparatus, and computer program for presenting targeted advertisements to a subscriber along with content selected by the subscriber in a content on demand (CoD) system. The content may be video, audio, data, computer applications, or other content that would be known to one of ordinary skill in the art. The targeted advertisements are selected based on matching advertisement profiles with subscriber profiles. The advertisement profiles and the subscriber profiles may be simple or complex. The advertisement profiles define traits and characteristics about an intended target market for the advertisement that include, but are not limited to, demographics, viewing characteristics, purchasing characteristics, and presence or absence of specific transactions. The subscriber profiles define traits and characteristics about the subscriber that include, but are not limited to, demographics, viewing characteristics, purchasing characteristics, and transaction records.

In a preferred embodiment, the subscriber profile is not released and is kept confidential. The subscriber profile may be maintained by the subscriber in a device controlling interaction with the CoD system (i.e., a set-top box (STB) for a video on demand (VoD) system). The subscriber profile may also be maintained by the CoD system and only be used to select targeted advertisements to be presented to the subscriber. Alternatively, the subscriber profile may be made of a multitude of data that is stored in a plurality of databases and that the subscriber has access to either directly (i.e., via the STB) or via the CoD system. According to one embodiment, the subscriber profile may be maintained in some combination of the above.

According to one embodiment in which the CoD system is a VoD system, the advertisement profiles will be downloaded to the STB (or personal video recorder (PVR)) and the STB will make a determination as to which advertisements should be presented to the subscriber along with the video that the subscriber selected. The selection by the STB may be done at the same time or prior to the selection of the video by the subscriber and transmitted to the VoD system along with the request for video. If the ads are selected in this manner, the ad profiles will have had to be loaded in the STB prior to (i.e., preloaded). Alternatively, the selection of the targeted ads may be done in the STB after the video request but prior to the delivery of the video. In this embodiment, the ad profiles may be preloaded or may be downloaded to the STB as soon as the video selection is made. The ads are then selected and the selections are transmitted upstream to the VoD system for delivery to the subscriber with the video. According to one embodiment in which the CoD system is a VoD system, the ads are stored in the PVR and are inserted locally.

According to one embodiment, the selection of ads by the STB (or PVR) is based on the ad profiles and the subscriber profiles having similar viewing characteristics. The viewing characteristics include, but are not limited to some subset of, favorite programs, favorite channels, favorite networks, favorite genre, channel change rate, holding factor and volume. The subscriber viewing characteristics are generated by processing subscriber viewing interactions with a TV. The processing includes summarizing, aggregating, and/or grouping the viewing interactions. According to one embodiment, the generation may also include the application of rules that define additional traits such as gender and age. According to one embodiment, the STB may monitor the viewing interactions over a plurality of viewing sessions and cluster similar viewing sessions in order to generate subscriber signatures. The subscriber signatures define traits about subscribers over a plurality of sessions. Different signatures may be associated with different subscribers or groups of subscribers. A single subscriber may have more than one signature with each signature defining traits associated with the subscriber at different times of the day or different modes of the subscriber. The present viewing interactions are compared with the subscriber signatures in order to make a determination as to which subscriber is currently interacting with the TV. Knowing which subscriber is likely interacting with the system allows a better determination of the ads that should likely be presented.

According to one embodiment, the ad profiles define the presence or absence of specific transactions as being the traits of the intended target market. In these cases, the selection of ads to be presented to the subscriber with the video is based on whether the subscriber meets these transaction criteria. Thus, the VoD system will query subscriber transactions to determine the existence or absence of these transactions. In a preferred embodiment the querying of subscriber transactions is performed by a secure third party.

According to another embodiment, the selection of ads may be made as a combination of viewing characteristics and specific transactions. Each ad may be selected based on a combination or some ads may be selected based on viewing characteristics and others may be based on specific transactions. Furthermore, household demographics, video selected, previous video selections, and other criteria may also be used in the selection of the targeted ads.

The targeted advertisement may be presented prior to, during, within or after the video. The definition of the advertising opportunities may be dictated by the video or may be dictated by the cost model that is selected either by the provider or the subscriber. For example, the cost model may be something along the lines of the less you want to pay for the video the more ads that you are presented with. According to one embodiment, the subscriber can not skip or fast forward the advertisements. According to an alternative embodiment, when the subscriber attempts to skip or fast forward the ad they are presented with an alternative ad in place of or in conjunction the targeted ad.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 illustrates an exemplary Content-on-Demand (CoD) system;

FIG. 2 illustrates exemplary video delivery networks;

FIG. 3 illustrates an exemplary system diagram of a Video-on-Demand (VoD) network;

FIG. 4 illustrates an exemplary system diagram of a Personal Video Channel (PVC) head-end based PVR network;

FIG. 5 illustrates an exemplary logic diagram of a VoD system;

FIG. 6 illustrates an exemplary playlist;

FIG. 7 illustrates an exemplary embodiment of content being divided into section so that ads can be inserted between each of the sections;

FIG. 8 illustrates an exemplary embodiment of a playlist being modified to account for a new ad;

FIG. 9 illustrates an exemplary embodiment of a playlist being modified to account for display of an alternative ad during a fast-forward event;

FIG. 10 illustrates an exemplary playlist including an alternative ad in the event of a fast forward event;

FIGS. 11A-C illustrate exemplary alternative advertisements being produced from an original advertisement; and

FIGS. 12 and 13 illustrates exemplary advertisement opportunities.

### DETAILED DESCRIPTION OF THE PREFERRED EMBODIMENT

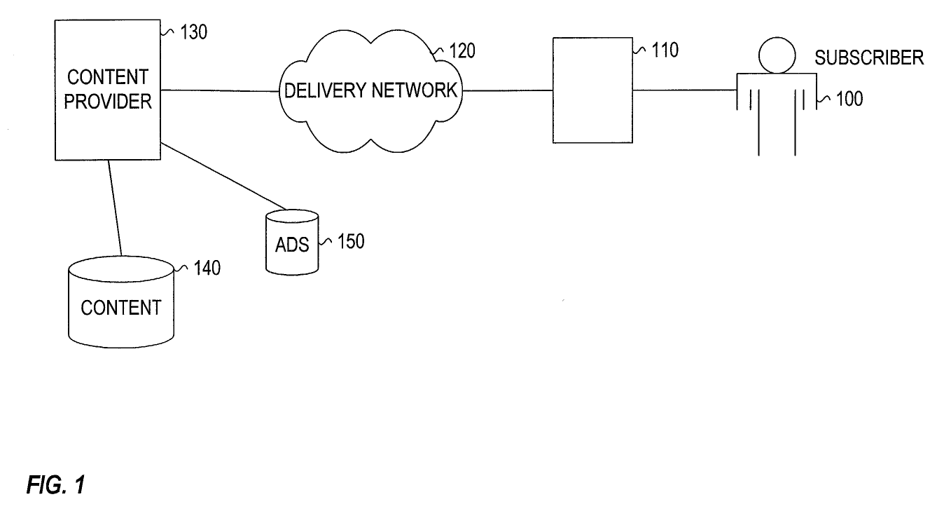

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose. With reference to the drawings, in general, and FIGS. 1 through 13 in particular, the present invention is disclosed.

Content on Demand (CoD) systems allow a subscriber to retrieve content at any time. The content may be video, audio, computer programs, computer applications, data or other content that would be well known to those of ordinary skill in the art. Advertisements (ads) may be delivered in addition to the content. The ads may be delivered prior to, after, within breaks in, in conjunction with or during the content. In a preferred embodiment of the present invention, the ads delivered with the content are targeted ads. FIG. 1 illustrates an exemplary CoD system. A subscriber 100 can select particular content to view at their interaction device 110. The interaction device 110 is the interface for the subscriber 100 to select content that they wish to receive. The interaction device 110 transmits requests for content to a content provider 130 via a delivery network 120. The interaction device 110 also receives the content from the content provider 130 via the delivery network 120 and provides the content to the subscriber 100.

The interaction device 110 may be a television (TV), a set top box (STB), a computer, a personal video recorder (PVR), a wireless device (i.e., phone, personal digital assistant (PDA)), or other devices that would be obvious to those of ordinary skill in the art. The content may be viewed, heard, other means known to those of ordinary skill in the art, or some combination thereof by the subscriber 100 on the interaction device 110. The delivery network 120 may be the Internet, a private network, a cable television network, a telephony network, a satellite network, a terrestrial wireless network, or other types of networks that would be obvious to those skilled in the art. Possible delivery network 120 architectures include but are not limited to hybrid fiber coax (HFC), fiber to the curb (FTTC), fiber to the home (FTTH), digital broadcast satellite (DBS), multichannel multipoint distribution systems (MMDS), local multipoint distribution systems (LMDS), or any of the twisted wire pair digital subscriber loops (xDSL) including high speed (HDSL), asymmetric (ADSL), very high speed (VDSL), and rate adaptive (RADSL).

The content provider 130 provides access to a multitude of content. The content provider 130 may be limited to a specific type of content (i.e., video) or may be capable of providing a multitude of different formats of content (i.e., digital video, analog video, audio, and IP streaming media). The content is stored in a content database 140. The content database 140 may be any type of storage devices now known or later discovered. While, the content database is illustrated as a single database it should be obvious to one of ordinary skill in the art that the content may be stored in more than one database and that the databases may in fact be distributed databases that are not even in a central location. In a preferred embodiment, the content provider 130 also has access to an advertisement database 150. The content provider 130 selects ads from the ad database 150 that would be applicable (i.e., targeted) to the subscriber 100. While the ad database 150 is illustrated as being connected to the content provider 130, it may be maintained by others than the content provider 130 and the results simply provided to the content provider 130 or the ads may actually be stored and inserted at the subscriber side (i.e., interactive device 110). Discussions of possible ways to target and deliver the ads will be described in more detail later.

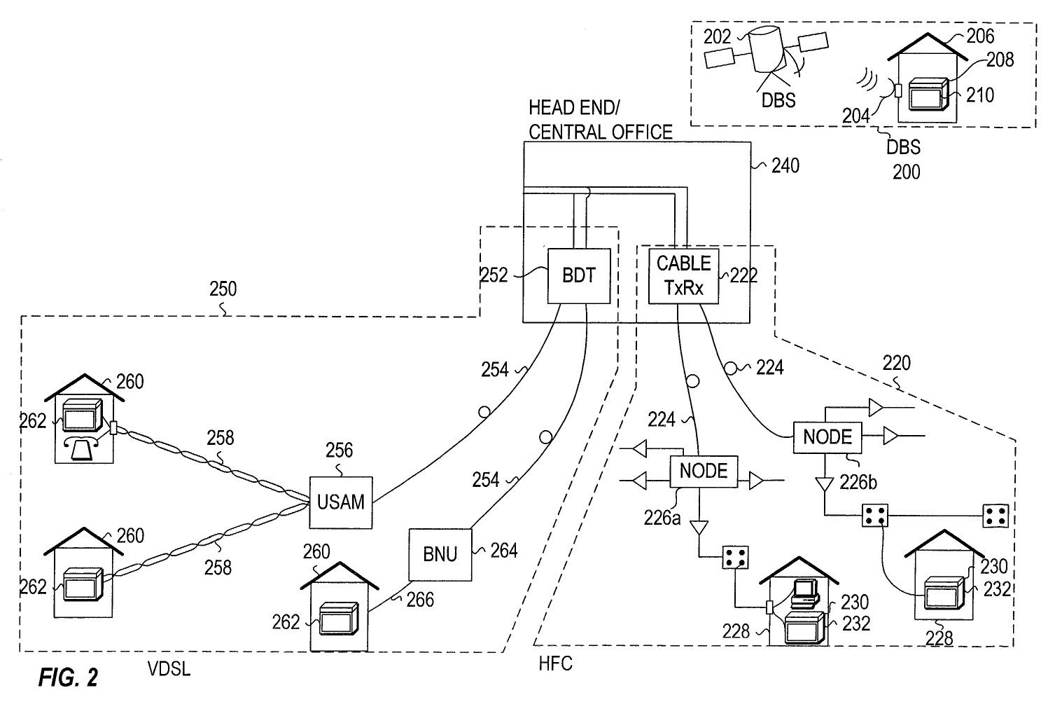

While the invention is intended to cover any kind of content that a subscriber 100 may wish to receive on demand, for ease of discussion the remainder of the application will concentrate on video on demand (VoD). When used herewithin the term VoD will be used to describe all of the various types of VoD or CoD that are now known or are later discovered. The current types of VoD systems will be discussed in more detail later. FIG. 2 illustrates exemplary embodiments of three of the more common types of video delivery networks that could implement VoD systems including DBS 200, HFC 220, and xDSL 250.

A DBS system 200 transmits a programming stream comprising upwards of a hundred channels of programming directly from a geo-stationary satellite transmitter 202 orbiting the earth to a receiving antenna 204 mounted on or near each subscriber's house 206. The programming stream is transmitted from the antenna 204 via a cable (not shown) to a satellite receiving station 208 in the form of a set-top box (STB) in the subscriber's house 206. The satellite receiving station (i.e., STB) 208 selects a channel and demodulates the signal for delivery to a monitor 210, such as a television. Most DBS systems 200 are arranged such that data can also be sent in the upstream direction, that is, from the STB 208 to the DBS provider. In most DBS systems 200, the STB 208 also is coupled to the telephone line and is designed and programmed to place telephone calls to the DBS service provider to periodically send information in the upstream direction. Such information commonly may comprise requests for Pay-Per-View (PPV) programs, requests for changes in the subscription (a request that one or more of premium channels be added to the service, etc.).

A HFC network 220, such as digital cable network, transmits multiple channels of TV information from a head end or central office (HE/CO) 240 via a cable network 222. Particularly, the channels are transmitted via cables 224, such as fiber optic cables, to nodes 226. The nodes 226 are essentially switching/routing stations that service multiple homes (usually a few hundred). The nodes 226 route the signals to individual subscriber households 228. For digital cable, the individual subscriber households 228 will have STBs 230 that select a particular channel from the transmit stream, demodulate it and forward it for display on one or more monitors (i.e., televisions) 232. Upstream information may be sent from the STB 230 to the HE/CO 240 via a dedicated upstream channel over the cable. In cable systems that do not support two-way communication, the upstream “channel” can be through the telephone as described above in connection with DBS systems 200.

A xDSL system 250 transmits programming over the regular telephone network. Particularly, TV signals are transmitted from a broadband distribution terminal (BDT) 252 within the HE/CO 240 via cables 254, such as fiber optic cables, to a universal service access multiplexer (USAM) 256 that delivers the data to multiple individual subscriber households 260 via regular telephone twisted wire pair 258 using VDSL modems and protocols. The USAM 256 receives a wide bandwidth signal comprising some or all of the television channels. However, because of the bandwidth limitations of twisted pair wire, typically only a limited number of channels of television programming (i.e., one to three) at a time can be delivered from the USAM 256 to the household. Accordingly, the subscriber has a STB 262 that is similar in functionality to the previously discussed STBs 232 for DBS and CTV, except that when the user changes channels such as by operating a remote control, the remote channel change signal is received by the STB 262 and transmitted to the USAM 256 which switches the channel for the user and begins sending the newly selected channel to the household.

Such systems are known as switched digital video (SDV) systems. SDV systems are essentially fully modem asynchronous two-way communication networks. Accordingly, the STB 262 can transmit information upstream via the same VDSL modem that receives the downstream signals. SDV systems typically operate using an asynchronous transfer mode (ATM) protocol that is well known in the networking arts. In an alternative embodiment, the TV signals are transmitted from the BDT 252 to a broadband network unit (BNU) 264. The BNU 264 delivers the data to individual households 260 using coaxial cable 266.

The delivery systems described with respect to FIG. 2 can deliver programming in various forms, including but not limited to digital video, analog video, or IP streaming media. The programming may be compressed in accordance with a variety of now known or later discovered compression standards, such as the current Motion Picture Expert Group (MPEG-2) standard for digital video.

It should be noted that STBs are described above with reference to FIG. 2. The current invention does not necessarily require STBs and in fact can use any other devices that can perform the same, similar, or additional functions. These devices may include, but are not limited to TVs, Video Cassette Recorders (VCR), Digital Video Recorders (DVR), Personal Video Recorders (PVR), Residential Gateways (RG), and computers. For simplicity, the term STB will be used herein to represent all the various devices that interact between the delivery network and the viewing device and the term PVR will be used herein to represent devices that contain memory and are capable of storing relatively large amounts of information (i.e., programming content) thereon.

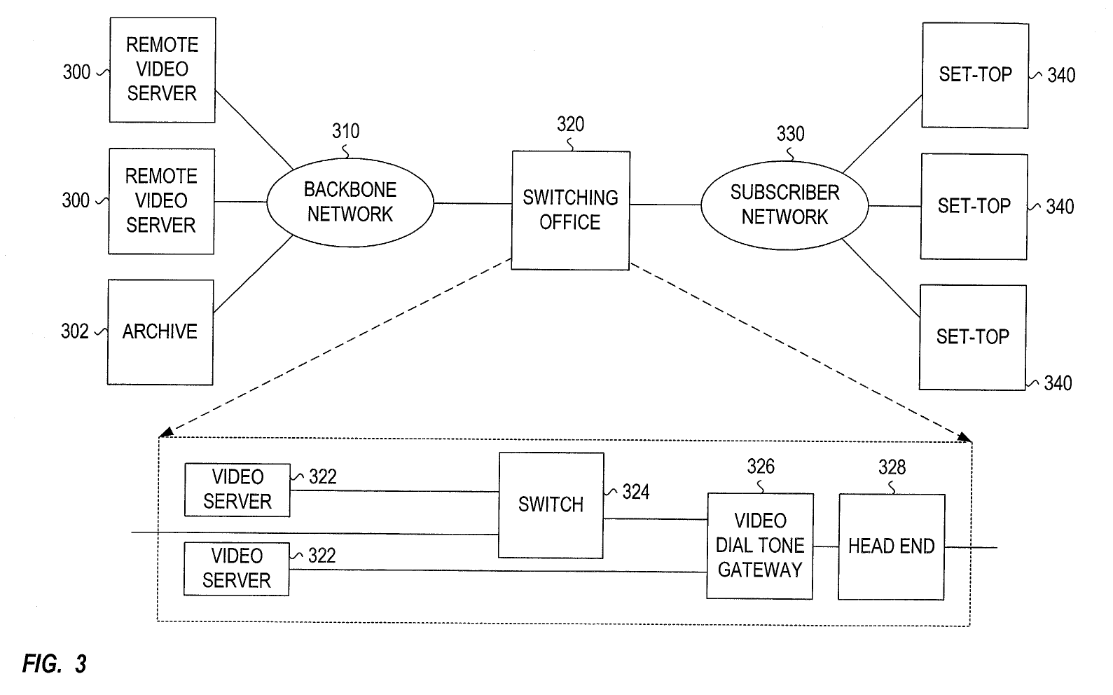

FIG. 3 illustrates an exemplary VoD system that includes remote video servers 300 that store video; an archive 302 that stores items such as infrequently viewed movies; a backbone network 310 that is used for the distribution of digital video from the remote video servers 300 to a switching office 320; a subscriber network 330, which connects the switching office 320 (more precisely head-end 328 within the switching office 320) to set-tops 340.

Within the switching office 320, various components are used to provide the VoD service including video servers 322, a switch 324, a video dial tone gateway 326 and the head-end system 328. The video servers 322 provide “local” or “edge” storage capability that allows video that is accessed more frequently to be stored closer to the subscriber than across the network on the remote video server 300 or archive 302. The switch 324 is used to direct traffic to the video dial tone gateway 326 that provides a subscriber interface as well as providing Operational Support Systems (OSS) and Traffic & Billing (T&B) functions. In operation, the video dial tone gateway 326 can present the subscriber with a menu for services which can guide the subscriber through the sources for video (content providers) and present the pricing information if the video is being sold on a per-unit basis (as opposed to a subscription service). The video dial tone gateway 326 thus insures that the subscriber can select the appropriate video content, that the content is accessed from the correct video server 300, 322 or the archive 302, that the head-end 328 and the set-top 340 are appropriately configured to transmit and receive the content respectively, and that billing records are created. Although the OSS and T&B systems are not illustrated in FIG. 3, they can be incorporated into the video dial tone gateway 326 or may be a separate systems located in the switching office 320 or elsewhere in the network.

The head-end system 328 represents the set of equipment that is needed to deliver the advertisement over the specific delivery platform in the subscriber network 330. As previously discussed with respect to FIG. 2, the subscriber network 330 may be a cable system based on HFC technology, a DSL network, or a land or satellite based wireless network. In the case of an HFC network, the head-end system 328 will typically multiplex a number of VoD streams together and modulate the multiplexed stream onto one or more Quadrature Amplitude Modulated (QAM) channels. For a HFC network, there will typically also be a return channel that may consist of a Data Over Cable System Interface Specification (DOCSIS) based modem in the STB and corresponding Cable Modem Termination System (CMTS) in the head-end 328 or a field location (such as a remote terminal). The return channel transports requests and commands from the set-tops 340 to the head-end system 328. As one of ordinary skill in the art would know there are alternative downstream modulation formats and return paths that can be utilized.

In the case of a telephone type network based on DSL technology, the head-end system 328 can consist of a terminal such as a Broadband Digital Terminal (BDT) or Host Digital Terminal (HDT) that receives video signals and prepares them for transmission to field located distribution equipment in the subscriber network 330. The transmission is typically via a fiber optic connection and is done in stages in which the fiber carries a signal from the switching office 320 to a terminal located in the field such as a Universal Access Multiplexer (USAM) or Digital Subscriber Line Access Multiplexer (DSLAM). From this point in the network the signals can be transported to the set-top 340 over twisted wire pairs using one of the DSL transmission technologies. Alternatively, the equipment in the network may be fiber optic based such that the transport to the home is entirely over a fiber optic connection, thus forming a Passive Optical Network (PON) or all optical Fiber to the Home (FTTH) network.

A distinction between the HFC network and the networks used by telephone service providers is that in the HFC network the bandwidth is typically shared between all of the subscribers on a cable node, whereas in a DSL network each subscriber has an individual connection with a pre-determined amount of bandwidth. This has an impact on the design and implementation of the head-end system 328, but should not affect the VoD functionality presented to the subscriber.

Satellite and land based wireless VoD systems will have head-end systems 328 which are yet distinct from cable and telephone network head-ends. Satellite systems can utilize a variety of return paths including satellite uplink, telephone line, Internet, or cable based. Both use sharing of the bandwidth on the downstream, with the satellite system extensively sharing bandwidth across the footprint of the satellite system.

The VoD system can also be based on Internet Protocol (IP) and can use streaming media techniques, including unicast and multicast, to deliver the video across the backbone and subscriber networks (310 and 330 respectively) and to the set-top 340. Using the IP protocol allows for flexible delivery of the video, independent of the transmission technology in the subscriber network 330. The IP protocol will also provide for the ability to easily transport and store video within the home, thus supporting in-home networking and incorporation of the subscriber set-top 340 or personal computer into the VoD network.

According to one embodiment of the present invention, the content being requested by the subscriber may be content that the subscriber previously requested that the VoD system record (i.e., the VoD system acting as a head-end based personal video recorder (HE PVR), also known as a Personal Video Channel (PVC)). The PVC provides the user with PVR functionality without the need for the subscriber to have a PVR by using the storage inherent to the VoD system. The PVC allows the subscriber to record programs delivered on the TV network without the need for any equipment.

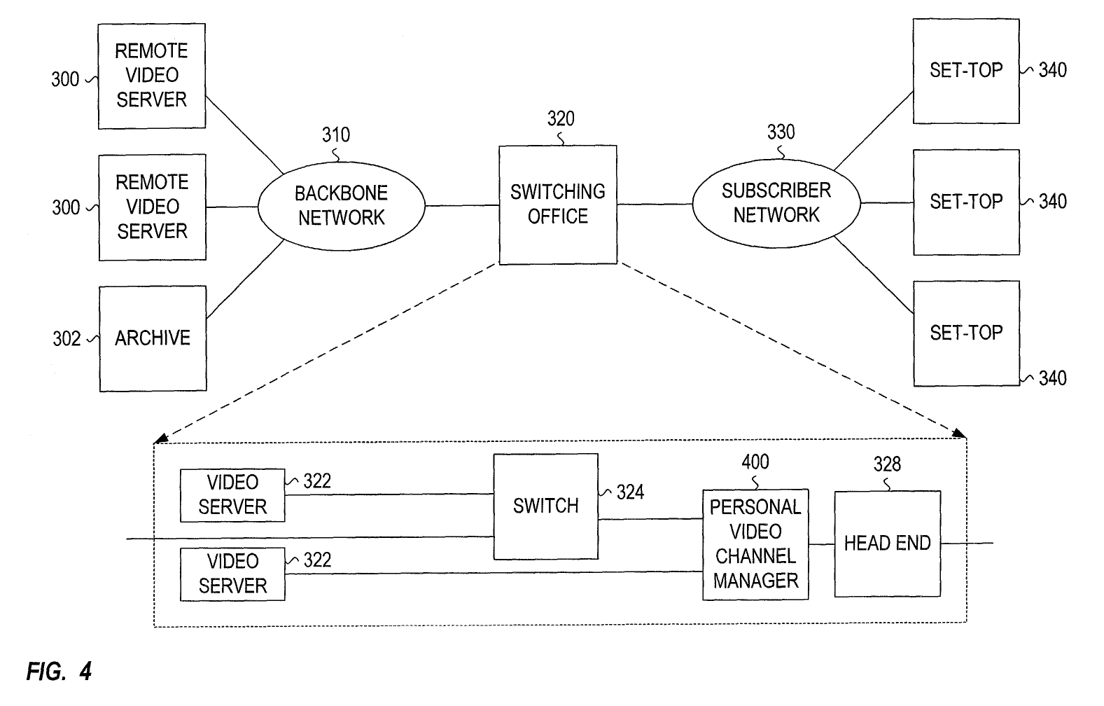

FIG. 4 illustrates an exemplary implementation of a HE PVR. In this embodiment, the video dial tone gateway 326 of FIG. 3 is replaced by a personal video channel manager 400. The personal video channel manager 400 provides the PVR functionality to subscribers by managing their stored programs and accessing the stored programming on command, just as in a VoD system. The principal distinction between the VoD system and the PVC is that in the PVC recording is enabled so that users can request that a particular program be stored. In the event that the programming is a live event and therefore not presently stored, the personal video channel manager 400 insures the programming is recorded on video server 322 or on another storage unit. If more than one user requests that a program be recorded, personal video channel manager 400 notes that the program has already been recorded and can prevent additional copies from being made. According to one embodiment, the PVC may automatically record all prime time television programming and make it available to subscribers for a certain time frame (i.e., one month).

The VoD systems illustrated in FIGS. 3 and 4 can be used to deliver video in various types of “on demand” formats including, but not limited to, near (NVoD), quasi (QVoD), or subscription (SVoD). Moreover, VoD also includes the case where the content selected by the subscriber is downloaded to and stored on the subscribers PVR and is then controlled (i.e., play and VCR functions) from the PVR. The downloading of the on demand content may be done over the network (depending on bandwidth available) or via a separate connection (i.e., Internet). All of the content may be downloaded and stored on the PVR prior to the subscriber starting to view the content or the subscriber may start to view the content as soon as some of the content is downloaded and stored thereon. When used herein, the term VoD is meant to capture all possible variations of VoD. The video may be programs that the provider has stored (FIG. 3) or may be programs that the subscriber has had the PVC record for them (FIG. 4).

NVoD offers the subscribers the possibility of viewing content at predefined intervals of time. For example, popular content (i.e., new movie releases, movies with popular actors) may be available for viewing every five minutes, while for not-so-popular content (i.e., older movies, B-rated movies, foreign movies) may be available less frequently, such as every half hour. As the content is not being directed to each individual subscriber, the subscribers cannot fastforward, rewind or pause (i.e., control the VCR functions) as they would if they had complete control of the video as would be the case with a VCR, PVR or VoD. The VCR functions in NVoD are limited by how often the program is available (i.e., being transmitted to subscribers). That is, if the movie is run every five minutes the subscriber can only fast forward or rewind in five-minute segments (move up or back a time interval), or continue playback from a pause at five-minute increments (move back a time interval). In some NVoD embodiments where the subscriber has access to a storage medium such as a PVR, a first portion of the program is stored in the PVR and then the rest of the program is stored as it is played This enables the subscriber to fast forward or rewind through the content without the limitations of NVoD. This type of embodiment is often referred to as NVoD emulation of VoD.

QVOD offers subscribers the availability of viewing content after a predefined number of subscribers have agreed to purchase the content. For example, a QVOD system may be set up to run a particular movie every half hour if at least 100 subscribers have signed up for the movie. The subscribers can perform VCR-functions in a similar way to that described above with respect to NVoD.

SVoD provides the subscriber with access to certain movies over a certain time period for a certain one-time fee. For example, for a monthly fee of $30 the subscriber may be able to view any movie running on HBO for that month. As the content would be delivered specifically to each subscriber, SVoD supports the VCR functions.

From an advertiser's perspective, VoD offers a tremendous range of possibilities for directing advertisements, including traditional 30 second commercials, infomercials, trailers and promos as well as various types of virtual advertisements and overlays, as will be described herein. In a preferred embodiment, the ads can be targeted to the subscribers. There are numerous methods for targeting ads that will be discussed in greater detail later herein. According to one embodiment, the ads that are targeted to the subscribers in the VoD content can be coordinated with ads that were displayed to the subscriber while they were interacting with the television prior to requesting the video (i.e., ads displayed in television programming, ads displayed in the EPG), whether those ads were targeted or not (default ads).

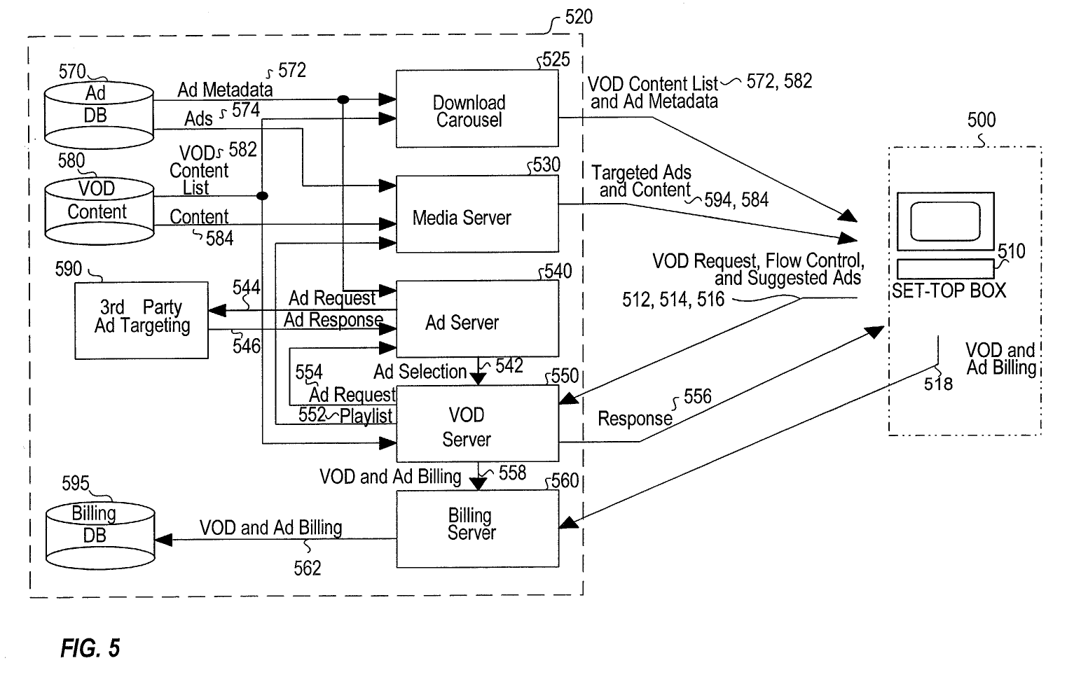

FIG. 5 illustrates an exemplary logical layout of a VoD system that includes delivering ads (preferably targeted ads) to the subscriber along with the content requested. The system consists of a subscriber side 500 and a network side 520. According to one embodiment, the system may be designed as a client-server architecture in which the subscriber side 500 acts as the client and the network side 520 acts as the server. The subscriber side 500 represents the functionality that would be located within the subscriber's residence (or other location where subscriber would be viewing the video on demand). The equipment that would make up the subscriber side 500 includes a viewing device, such as a TV, and an interface to the network side (delivery network) such as a STB 510. The network side 520 represents the delivery network and, in particular, may represent the HE/CO of a video delivery network.

As illustrated, the exemplary network side 520 consists of a download carousel 525, a media server 530, an ad server 540, a VoD server 550, a billing server 560, an ad database 570, a VoD content database 580, 3rd party ad targeting 590 and a billing database 595. The ad database 570 stores ad metadata (in simple terms descriptions of the ads) 572 and ad media files (ads) 574. The VoD content database 580 stores a VoD content list 582 and VOD media files (VoD content) 584. The download carousel 525 can retrieve the ad metadata 572 and the VOD content list 582 from the respective databases 570, 580 and transmit the data 572, 582 to the STB 510. As one skilled in the art would recognize, the download carousel 525 transmits the files that need to be updated to the subscriber at appropriate times (i.e., every night, every 8 hours) or when the content is required. It should be noted that the ad metadata 572 need not be sent to the STB 510, and in fact, would probably only be sent to the STB 510 if the STB 510 did some type of profiling on the subscribers and could use this profiling to select potential ads based on the ad metadata 572 (discussed in more detail later).

The VoD server 550 receives a VoD request 512 from the subscriber and validates the request 512 by ensuring the request is in the VoD content list 582 and ensuring that the subscriber or household is authorized to receive that content (i.e., blocking out adult material). The VoD server 550 sends a response 556 to the subscriber about whether the request is successful or not. As will be described in more detail later ads may be pre-pended or post-pended to the content, may be inserted in advertisement opportunities (avails) with the content, or may be the type of ads that can displayed with the content (i.e., bugs). The ad server 540 receives an ad request 554 from the VoD server 550 and selects appropriate ads 542 to deliver with the VoD content 584. The ad server 540 likely uses the ad metadata 572 for the available ads and data related to the VoD content selected, the household, the subscriber or some combination thereof to select the ads. According to one embodiment, the ad server 540 may select the ads with the help of a 3rd party 590 (doing ad targeting) by sending an ad request 544 and receiving an ad response 546. According to one embodiment in which the STB 510 has some profiling capabilities, the STB 510 may forward suggested ads to the VoD server 550. The suggested ads 516 may be transmitted at the same time as the VoD request 512 or at different times. The selection of ads will be discussed in more detail later.

The VoD Server 550 then prepares the playlist and forwards it to the media server 530. The media server 530 retrieves the ads 574 and the VoD content 584 from the respective databases 570, 580 based on a playlist 552. The media server 530 then delivers the data 574, 584 to the STB 510 in the order described in the playlist 552. The subscriber may fast-forward, rewind, pause, etc. the content by forwarding flow control commands 514 to the VoD server 550 to process. Once the playlist 552 has been established the VoD server 550 sends the data related to the ads and content 558 to the billing server 560. The billing server 560 also receives VoD and ad billing data 518 from the STB 510 as to whether the subscriber actually received and watched the content or not. The billing server 560 correlates the data and generates a bill 562 therefrom. This bill 562 may then be stored in a bill database 595 that would likely be part of a monthly invoice sent to the subscriber.

The logical layout is meant to demonstrate the ad targeting and delivery functionality. It should be obvious to one of ordinary skill in the art that this is not a physical model and that the headend components can be different applications that reside on different servers, different applications on the same server, or different functionality in the same program. Below is a more detailed description of each of the logical modules.

STB 510

The STB 510 often includes a program guide (often referred to as electronic program guide (EPG) or interactive program guide (IPG)) that displays the programming that is available by time, channel, genre, etc. For simplicity when used herein the term EPG will be used to represent any type of program guide now known or later discovered that can be used by the viewer to search for and select programming. The EPG in effect acts as a user interface allowing the subscriber to select content to view or record, to set reminders, to suggest content, and other functions that would be well known to those skilled in the art.

According to one embodiment of the current invention, the EPG uses the VoD content list 582 to incorporate the VoD content therein. Thus, the EPG acts as a navigation system to allow the subscriber to purchase VoD content. As one skilled in the art would know, there are numerous different types of EPGs that are in use today, and the current invention is intended to be applicable to all of these different EPGs and not be limited to any specific type of EPG. To retrieve VoD information in an EPG, the subscriber may need to push a VoD button that would then take the subscriber to a VoD screen. The screen may then prompt the user to select how they wish to view the VoD as the EPG may sort the VoD content using a variety of methods including alphabetically by title, by genre/category of the content, by release date, by popularity, and numerous other manners that would be obvious to one of ordinary skill in the art. According to one embodiment, the subscribers preferred method for viewing VoD content will be the default means for presenting VoD data. The current invention is no way limited to incorporating VoD content in EPGs as discussed above. Rather, there are almost an endless amount of ways that VoD content could be organized and presented within an EPG that are well within the scope of the current invention.

The STB 510 receives the VoD content list 582 from the headend (server side 520). The VoD content list 582 may be downloaded to the STB 510 in its entirety and then saved to disk or flash memory. Alternatively, the STB 510 may query the server side 520 for a partial version of the VoD content list 582 as the subscriber navigates through the VOD list provided by the EPG. The VoD content list 582 includes information about the content in addition to listing the available content (discussed in more detail later).

The VoD content list 582 need not be incorporated in the EPG. The VoD content list 582 can be displayed on a separate channel available on a website, or other means that would be obvious to one of ordinary skill in the art. The subscriber can view the channel or navigate the website to determine the available content. The subscriber can order the content on the website, via telephone or other means that would be obvious to those skilled in the art.

When the subscriber selects a VoD program, the STB 510 transmits a request 512 to the VoD server 550 that specifies the subscriber information, and content identifier. If there are multiple VoD cost models (i.e., more ads included the less it costs to view the content) then the VoD request may also include the cost model. In some embodiments, the cost of the content may also be transmitted to the VoD server 550. The STB 510 awaits a response 556 that indicates approval or denial. If the response 556 is a rejection, it will include a reason code and optional description.

VoD systems allow a subscriber to use VCR functions (i.e., rewind, pause, fast-forward, stop the playback) while viewing an on-demand program. Thus, when the STB 510 begins receiving content from the media server 530, the subscriber can manage the flow of content (flow control) by implementing the VCR functions. If the on demand content is downloaded (partially or completely) to a PVR prior to the subscriber beginning to view the content, the PVR can manage the flow control and flow control commands.

Alternatively, the flow control is managed back at the server side. Thus, the flow control commands 514 are transmitted from the STB 510 to the network side 520 where they are processed. Once the flow control commands are processed the results (i.e., fast forward) are displayed to the subscriber. It should be noted that there may be a delay between the actual selection of a flow control command by the subscriber and the implementation (viewing)of the command. If ads are included in the content it is likely that the subscriber would attempt to fast forward or skip through the ads. In order for the advertiser to get some value, the content provider may not allow the subscriber to fast-forward or skip ads. That is, according to one embodiment the network side 520 may not permit VCR functions during ads. Alternatively, the fast-forward and skip functions are not disabled but instead are modified to present the subscriber with a short alternative advertisement in place of a fast-forwarding ad (or may be in conjunction with the fast forwarding ad). The alternative ad may be created from the original ad or be a separate ad that is transmitted along with the original ad. This alternative ad is generated using Expanse Networks ADhance™ technology that will be described in more detail later and is described in applicants co-pending patent application previously incorporated by reference and identified by docket number T738-10.

The STB 510 tracks the content and the ads that are viewed. The tracking of ads includes the ads that were received and whether the ads or the alternative ads were viewed. This information is transmitted back to the headend for advertiser billing purposes. The tracking of content tracks the amount of time that the content is viewed and whether the entire program is received. This information is transmitted back to the headend for billing purposes. This transmission may include the subscriber ID, content ID, viewing duration, and reason code if the content was not completely viewed. Possible reasons for premature termination may include, but are not limited to, the viewer terminated the session, poor video quality, loss of video from the source, or the media server could not be found.

According to one embodiment, the STB 510 may assist in the selection of targeted ads for the household or subscriber. The STB 510 can assist in the selection of ads by generating a profile of the subscriber. The profile is generated by monitoring among other things channels viewed, channel changes, volume control, EPG activation, and time. The monitored activity can be aggregated to generate viewing characteristics. Data related to the programming (program data) can be retrieved to further define the viewing characteristics. Program data includes information including program genre, actors, networks, etc. The viewing characteristics can identify such attributes as channel change rate, favorite programs, favorite genre or programming, favorite networks, dwell time, etc. Moreover, the viewing characteristics may be broken out by day or day part. According to one embodiment, the STB may also monitor the subscribers interactions with advertisements, The monitoring of subscriber activities during advertisements may include whether the subscriber tends to view ads or skip ads, what the subscriber does with the volume during ads, what ads the subscriber is more susceptible to watch, etc. These viewing characteristics may be applicable to a subscriber as they may want to target subscribers that have certain viewing patterns.

According to one embodiment, the STB may apply heuristic rules to the monitored interactivity and/or viewing characteristics to generate a non-viewing profile of the subscriber that-may include demographics, product preferences, interests, etc. The heuristic rules predict traits about the subscriber based on some viewing aspect. For example, woman are more likely to watch soap operas, men are more likely to watch football, individuals with higher income change channels faster. The heuristic rules may be deterministic or probabilistic in nature The overall profile of the subscriber based on viewing transactions can include viewing characteristics and deterministic and probabilistic representations of other traits about the subscriber including, demographic, product preferences and interests. The applicant's co-pending patent applications previously incorporated by reference and identified as T702-00, T703-00, T702-00PCT, T702-02 and T702-03.

The STB 510 may also determine which subscriber or combination of subscribers is watching television at that point in time by comparing the monitored interactions for that viewing session with profiles recorded over several sessions (signatures). To accomplish this, a profiling agent may be resident at a viewer's receiver and be responsible for profiling a single household, and distinct individual members of that household. The set-top box profiler monitors the viewing behavior and other receiver interactivity of the viewers including their viewing preferences and utilizing data about programming viewed or not viewed, derives characteristics about and generates profiles of the household and of individual viewers within the household, In a preferred embodiment, the profiles are comprised of profile categories, including the categories of preferred programs, preferred networks, viewing duration, channel change frequency, and holding factor per program or program category.

In a preferred embodiment, the profiler identifies different viewing sessions, a period of time during which viewership (i.e., one or more specific viewers) is static and does not change, based on viewing and other habits and preferences exhibited by the viewer or viewers, and creates session profiles for each session. Signature profiles are created from one or more correlated session profiles, and subsequent session profiles are correlated and matched with existing signature profiles. Sessions may be defined by, for example, the cycling of power (on/off) of the set-top box, a specific window of time or day-part, periods of inactivity, and monitoring channel change, viewing and other viewer activity.

In one embodiment, the profiler comprises an event queue that stores viewer interactivity as viewer-generated events. The profile engine accepts events from the event queue, reads database information (e.g., program data), and processes the events to produce the subscriber profiles. Events are dispatched to the profiling engine based on the clock time, and each of these events may be used to update and modify the viewer's profile. In a preferred embodiment the profile engine uses filters to process events. Each filter may handle one or more profiles elements, determining whether or not each specific event is applicable to (i.e., should be used to update) one or more profiles.

In one embodiment, automatic session detection uses channel change and other information to dynamically determine which viewer is watching television at any given time. In a preferred embodiment, reliable viewer identification is accomplished and more complete, updated and accurate profiles of particular viewers are generated, by combining current session data with historical data for those viewers. This historical data, or signature, is an aggregation of session data for a particular viewer or type of viewer, and reflects a set of viewing and interactivity habits. During a specific session, as the profiler collects viewer interactivity session data, the profiler continuously correlates the session data with existing signature data in order to match the session data to a specific signature. This correlation associates long term viewing habits with a particular user based on their short term viewing habits. Moreover, matching session data with a signature identifies a particular viewer and an associated profile.

In one embodiment, the signature profile represents an individual viewer. In an alternate embodiment, the signature profile represents a plurality of household viewers. In another embodiment, the signature profile is a standard profile, created independently of any session data or created from aggregated session data from a plurality of household. The profiling and identification of subscribers is discussed in more detail later and are captured in detail in Applicants co-pending applications that have previously been incorporated by reference and identified as T705-01, T734-00, T734-10 and T735-00.

According to one embodiment, the STB 510 may select the ads itself by comparing ad metadata 572 to the subscriber profile. In this embodiment, it would be necessary for the ad metadata 572 to be transmitted to the STB 510. The ad metadata 572 may be transmitted to the STB 510 at set intervals (i.e., once a day), each time the viewer interacts with the VoD portion of the EPG, each time the viewer selects a VoD (VoD request), each time the VoD content is updated, or other means that would be known to those of ordinary skill in the art. The ad metadata 572 may be simple or complex. For example, simple ad metadata 572 may be nothing more than the fact that the ad is meant for subscribers falling in a “Young and Single” category that may be defined as subscribers being less than 30 years old that are not married and have no kids. However, the ad metadata 572 may be more complex and define many different demographics, viewing characteristics, and interests. According to one embodiment, there may be a limited number of ad profiles that can be selected (i.e., 10) or the ad profiles are grouped together into a limited number (i.e., 10). The ad profiles may be selected by the advertisers, by the subscribers, by the content provider, or by some third party. Having predefined profiles simplifies the process of finding a match between a subscriber and an ad.

The subscriber profile may also be simple (i.e., viewing characteristics) or complex (i.e., demographics, interests) as previously described. The STB 510 may only recognize a limited number of profiles (i.e., 10) and thus if there are more than that number of subscribers (or groups of subscribers) the subscribers are grouped together. Thus, each subscriber or set of subscribers would have one of a limited number (i.e., 10) of profiles. The profiles may be grouped based on how similar they are to each other, based on how similar they are to predefined profiles (either generated by advertiser, content provider, or third party).

If the ad and subscriber profiles are both limited to predefined profiles (i.e., profile type 1 to 10) finding a match is easy. The more complex the profiles the more complex it is to determine a match. To find a match, the STB 510 will make a comparison between like features (i.e., viewing durations, channel change rate, favorite genre, family size, gender) in each of the profiles. The features may be weighted so that features important to either the advertiser or the subscriber are given higher weighting factors. In one embodiment, it is possible that one feature is so important that a match can not be found unless there is a match between those features, regardless of how similar the remaining profiles are. For example, no match between an ad and a subscriber unless the subscriber makes over $100K, even if all other elements of the profiles are an exact match.

According to one embodiment, the STB 510 ranks the ads based on the amount of correlation between the ad and the subscriber. Whether the STB 510 simply determines matching ads or ranks the ads, the results (suggested ads) 516 are sent to the server side 520 for further processing. The results 516 may be sent with the VoD request 512 if the ad metadata 572 was available ahead of time (prior to the VoD request 512). In fact, the STB 510 could periodically update the list of ads that would be acceptable 516 and send it to the server side 520 at predefined intervals (i.e., once a day). Alternatively, the suggested ads 516 may be sent to the server side 520 at some point after the request 512 has been made (i.e., after the request has been approved 556). In any event, the server side 520 generates a playlist 552 including the ads to be transmitted with the selected content based on the input from the STB 510. The selection of ads based on a correlation between an ad profile and a subscriber profile is discussed in more detail in applicant's co-pending patent applications that have previously been incorporated by reference and identified as T702-00 and T702-00PCT.

VoD Server 550

After the subscriber selects VoD content to view, the STB 510 submits a VoD request 512 to the VoD server 550. The request 512 identifies the subscriber and the requested content, and may also include items such as the cost model, cost, or other information. The cost model may include the content that the subscriber has access to (i.e., may not have access to adult material without a password, may require a password for content having foul language or excessive violence), the number of ads to be added to the content, the control of VCR-type functions during the ads, the replacement of ads with alternative ads during fast-forward or skip commands, and other information that would be obvious to one of ordinary skill in the art. The VoD server 550 must also ensure that the content is available for delivery at the specified time selected by the subscriber. Moreover, the VoD server 550 may verify that the subscriber is permitted to access the specified content, and that the content is available for the identified cost according to the associated cost model.

The VoD server 550 responds to the STB 510 by indicating whether the request 512 was approved or denied. If the request 512 was denied, the response 556 includes a reject code and an optional description of the reason. If the request 512 is approved, it is likely that the content will not start playing instantaneously but may take some time (i.e., a few seconds or more based on the availability of equipment, location of content in databases, length of content, and other criteria that would be well known to those of ordinary skill in the art). According to one embodiment, the VoD server 550 may instruct the subscriber as to how long it will take the video to start playing (i.e., 30 seconds).

In a preferred embodiment, the content delivered to the subscriber will also include ads and as such, the VoD server 550 will manage the insertion of ads within the content (i.e., pre-pend, post-pend, within). The VoD server 550 requests ads from the ad server 540. The request 552 may be for specific ads (in the embodiment where the STB 510 provides a list of targeted ads) or may be for ads that are targeted to the subscriber. The location of the ads within the content may depend on the content that is requested. For example, if the subscriber requests a movie it is likely that the ads will be pre-pended, post-pended, or both. Whereas, if the content is a syndicated program (i.e., “I Love Lucy” episodes) it is likely that the ads will be inserted in ad opportunities (avails) either already existing or created within the content. According to one embodiment, numerous cost models will be available and the number of ads transmitted to the subscriber will depend on the cost model. Alternatively, there may be a single cost model that includes some number of ads.

According to one embodiment, the subscriber may be delivered ads while the content is being retrieved (i.e., pre-pended) regardless of the content. That is, in the time it takes the system to retrieve the content, the system can display ads to the subscriber. The ads may be standard ads that everybody receives during the delay (i.e., ads for products or services, promo ads for other VoD content) or they may be targeted ads. The ads may be targeted based on numerous different methodologies, some of which have been touched on (STB profile) and others that will be discussed in greater detail later. For example, as briefly discussed above, the STB may suggest ads to be delivered that meet a certain profile type. According to one embodiment, the ads delivered to the subscriber while the system is cueing up the content are identified as such. That is, these ads are displayed while the system informs the subscriber how long it will take the content to be ready. This may be done by displaying the ad on a portion of the screen while a counter displays the remaining time another portion, by overlaying the timer over the ad, by displaying the timer as a picture-in-picture, with computer graphics or other means that would be obvious to those of ordinary skill in the art.

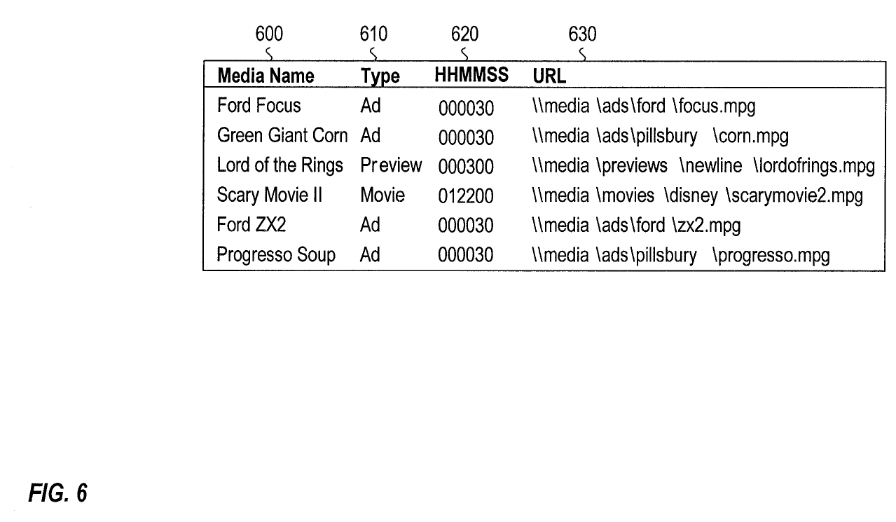

Once the VoD server 550 receives the selected ads (targeted ads) the VoD server 550 generates a playlist 552 that includes the ads. FIG. 6 illustrates an exemplary playlist that includes content and ads. As illustrated the playlist includes a media name 600, a media type 610, a media duration 620 in HHMMSS format, and a location for the media (which as illustrated is a URL but is not limited thereto). In this exemplary playlist the content (Scary Movie II) is preceded by two ads and a preview (likely a VoD preview) and is proceeded by two ads.

The VOD server 550 interfaces with the media server 530, either directly or indirectly, to verify that the media server 530 can support the new subscriber request, to verify that the requested content and ads are accessible to the media server 530 and to direct the media server 530 to deliver the ads and content. The VoD server 550 can direct the media server 530 by forwarding the playlist 552 directly to the media server 530 wherein the media server 530 45 follows the playlist 552. Alternatively, the VoD server 550 maintains the playlist 552 and monitors the media server 530 and sends individual trigger commands to the media server 530 when new content should be transmitted. According to another embodiment, the playlist 552 may be transmitted to the STB 510 and the STB 510 may then control the media server 530.

As previously discussed, the cost model may disable, the VCR functions for the ads or alternatively may replace ads with alternative ads (ADhance system) when the VCR functions are invoked. According, the VoD server 550 must handle flow control commands 514 correctly.

Finally after the content and ads are selected, the VoD server 550 generates billing information 558 and transmits it to the billing server 560. The billing information 558 includes the subscriber ID, content requested, ads inserted, and the results of the content and ad display. The billing information may also include cost model and price. If the content delivery is terminated early, the billing record tracks the amount of content that has actually been delivered as a refund or credit may be warranted.

Ad Server 540

The Ad Server 540 is responsible for selecting ads to deliver to the subscriber. The ads may be selected based on comparing a profile of the ad to profiles of the subscribers. The profiles of the ads would be selected by the company, advertiser, or media buyer and would represent a target market for the ad. As one skilled in the art would recognize, the target market for the ad could be represented in any number of items including, but not limited to, demographics, interests, purchasing patterns, viewing patterns or some combination thereof.

According to one embodiment, the subscriber profiles could be entered by the subscriber using a survey or questionnaire. In a preferred embodiment, the subscriber profiles are collected, aggregated or derived based on 3^{rd} party data, subscriber transaction and different rules associated with the transactions. For example, subscriber profiles may include the same type of profiles described above with respect to the ads. Accordingly ads can be targeted based on at least some subset of household demographics, consumer purchases, subscriber profiling (requires the help of the set-top box), content type, 3rd party applications, historical ad delivery information, other means obvious to those of ordinary skill in the art, or some combination thereof.

Targeting ads based on household demographics may be accomplished by using a third party provider that predicts the probable demographics of households by zip+4 or block group. This data is then equated to subscriber by cross referencing the traffic and billing data with the third party provider data. Having the probable demographics of the household allows the ad server 540 to match ads to the subscribers based on their demographics (ads having a target audience with the same demographics). Alternatively, the demographics can be generated by applying heuristic rules to viewing patterns as previously discussed with respect to the STB 510. The viewing preferences may simply be content requested (VoD and/or all content) or may be other viewing characteristics including, but not limited to channel changes, volume selections, and viewing times. Furthermore, demographics can be acquired by third parties that track product purchases (i.e., loyalty cards, credit cards) and infer demographics by applying heuristic rules to the purchase transactions or purchase characteristics. The generation of purchase characteristics will be discussed in more detail below. The generation of demographic traits based on consumer purchases is described in greater detail in applications patent that has previously been incorporated by reference and identified as docket number T706-00.

According to one embodiment, the household demographics are based on the 3rd party zip+4 data and are enhanced or modified using the viewing characteristics, purchasing characteristics or some combination thereof. According to one embodiment, subscribers may be grouped based on the derived household demographics (i.e., 3^{rd} party zip+4) being crossed referenced to the cable network layout. That is, each node, or branch within the delivery network may be assigned a demographic profile (i.e., average profile of all subscribers connected thereto) and all those subscribers connected thereto are also assigned that profile. The generation of node profiles (or microzones) is discussed in more detail in Applicants co-pending patent applications previously incorporated by reference and identified by docket number T719-00.

Ads selected based on consumer purchases would require the content provider to coordinate with the supermarkets of the credit card companies to generate a profile of the consumer purchases. The consumer purchase profile may aggregate the transactions into summary form, to identify the type of goods, the brands, the sizes, the price, etc. that the consumer is likely to purchase. The ad metadata would then identify these types of target markets. As previously discussed with respect to the viewer profiles under the STB 510 section, a correlation could be made between the consumer profile and the ad profile in order to select the appropriate ads. The generation of consumer profiles and the correlation of consumer and ad profiles are discussed in detail in Applicant's patents that have previously been incorporate by reference and identified by reference T706-00 and T707-00.

As discussed above with respect to the STB 510, the ads may be selected based on viewer profiles. The viewer profiles summarize the viewing patterns of the viewer including, but not limited to, channel changes and preferred content. Using viewing profiles enables the profiling to go from a household level to an individual level. That is, the subscriber profiles identify individual subscribers or group of subscribers as opposed to being representative of an entire household. Targeting individual viewers with advertisements requires a STB 510 with subscriber profiling capabilities (described above). In a preferred embodiment, the STB 510 never transmits subscriber profiling data out of the box. According to another embodiment, if the ad selection is based on the viewer profiles, the STB will delete ads from consideration that have been displayed to the subscriber more than a predetermined number of times. Alternatively, an ad may be moved up on the list if it has not been played for a while. According to another embodiment, if an ad has just been played in the programming, it may be desired to display a similar ad in the VoD content to emphasis the message. This coordination of ads may take place for ads that were placed in the different types of media including ads in programming, EPGs, ads in recorded programming, and alternative advertising including but not limited to product placement ads, overlay ads and bugs.

According to one embodiment, the ads may be selected simply by the content of the VoD request. That is the ads are either identified with that content, that content genre, or having a demographic profile similar to a predicted demographic profile of a viewer of that content.

According to one embodiment, the ad targeting is performed by a secure third party. The third party has access to multiple transaction records for the subscriber but does not release any of the transaction data but instead allows individuals to query the database of transactions. For example, Catalina Marketing maintains purchase information for households. A business relationship exists between the cable service provider and Catalina Marketing that allows the service provider to deliver ads targeted based on consumer purchases. Thus according to one embodiment, if Coke wished to provide advertisements to all individuals that had purchased Coke products within the 2 weeks previous to their VoD request, the service provider could query the 3rd party database to see if the subscriber meet the criteria. Alternatively, the service provider may send ad metadata 572 and an identifier for the subscriber (telephone number or some other identifier that could link the subscriber to their loyalty card) to the third party 590 and allow the third party 590 to respond with ads that meet the criteria defined in the ad metadata. As one skilled in the art would recognize the number of ad profiles that could be developed that relate to subscriber transactions is almost limitless. The ad profiles could define certain transactions happening (i.e., purchased product at least a certain number of times within certain time frame; have recently switched to purchasing a different product; have recently switched from purchasing a different product to purchasing this product; purchase the competitors products; viewed certain program at least a certain number of times over a certain period; record certain programs) or certain transactions not happening (i.e., have not purchase the product for over a certain period of time; have not used coupons for a certain time; have not viewed a certain genre of program; have not purchased VoD content). The current invention is in no way intended to be limited to the ad profiles described above, as there are numerous other transaction related ad profiles that would be well within the scope of the current invention.

As one skilled in the art would recognize the ad targeting can be based on any combination of the above mentioned selection criteria or other criteria that would be known to those of ordinary skill in the art. If ads were based on a combination of criteria the ad server may collect and aggregate the various profile elements (i.e., viewing, consumer, demographic) and then compare the ad profile to the aggregated profile. However, for privacy concerns (or other reasons) all the profile data may not want to be (or be capable of) being stored in a central location. Thus, according to one embodiment an ad profile may have to be compared to several distinct subscriber profiles and then the results of the correlations need to be analyzed by the ad server 530. For example, ad metadata 572 may be sent to the STB 510 to compare to the subscriber viewing profile, while the ad profile is also compared to the demographic profile provided for the household the 3^{rd} party zip+4 database. The ad server 530 determines what ads meet a predefined threshold of correlation for each profile type.

In another embodiment, the ad server 530 may query (i.e., quantum advertising™) the appropriate profile databases and/or transaction databases (plurality of sources) to determine if a subscriber should receive a particular ad. The plurality of sources may include distributed or centralized databases that include viewing characteristics, purchasing characteristics, transaction characteristics, statistical information and deterministic information. The plurality of sources may be public and/or private databases. In one embodiment, the viewing characteristics data is generated within the current system by monitoring subscriber interaction with the television and aggregating the data to form the viewing characteristics. The subscriber interaction includes at least some subset of channel changes, volume changes, EPG activation and record commands. The viewing characteristics include at least some subset of program preference, network preference, genre preference, volume preference, dwell time, and channel change frequency.

The statistical information may be collected from a variety of sources including private and public databases. For example, MicroVision, a product of Claritas, Inc. of San Diego, Calif. provides demographic segment statistical information for market segments defined by ZIP+4 (approx. 10-15 households). The statistical information may also be generated by applying heuristic rules to the subscriber characteristics. For example, heuristic rules can be applied to the viewing characteristics to generate a probabilistic demographic make-up of the subscribers. The deterministic information can be obtained by having the subscriber answer a questionnaire or survey. The deterministic information may include at least some subset of demographics and interests.

In accordance with the principles of Quantum Advertising™, a subscriber profile may be contained in a vector, such as a ket vector |A>, where A represents the vector describing an aspect of the subscriber. The ket vector |A> can be described as the sum of components such that

|A>=(a₁ρ₁+a₂ρ₂+ . . . aₙρₙ)

+(b₁σ+b₂σ₂+ . . . bₙσₙ)

+ . . . +(e₁Ω₁+e₂Ω₂+ . . . eₙΩₙ)

wherein a₁ through eₙ represent probability factors and ρ₁ through ωₙ represent characteristics selected from at least a subset of viewing characteristics, purchase characteristics, transaction characteristics, demographic characteristics, socio-economic characteristics, housing characteristics, and consumption characteristics. The system may also form groups of subscribers having similar profiles. The groups may be formed based on cable television (CTV) system elements such as head-end, node or branch.

The correlation between ad profile and subscriber profile can be performed by applying an operator to the subscriber profiles in the form of ket vectors to determine if a particular ad is applicable to the subscriber. Quantum Advertising™ is discussed in more detail in Applicants co-pending application that have previously been incorporated and identified by T702-03 and T741-10.

According to one embodiment, the selection of some ads may be based on one criteria while the selection of other ads may be based on other criteria. For example, if three ads were to be targeted for the specific content requested, the first ad may be selected based on household demographic, the second ad may be selected based on consumer purchases, and the third ad may be selected as a combination of consumer profiles and viewer profile. According to one embodiment, the selection of what method of ad selection to use is based on the content provider and may simply be based on the ads that can generate the most revenue.

According to one embodiment the ad server 530 may generate an ad queue for the subscribers and place the ads in the VoD content based on the ad queue. It is also possible for the ad queue to be used to target ads within standard avails within standard television programming. In one embodiment, the ad queue would coordinate the targeted ads inserted within standard programming and VoD programming. The ad queue could also be used to coordinate ads that were inserted within the EPG used by the subscriber.

Media Server 530

The media server 530 delivers the audio and video content to the STB 510. The media server 530 can use a variety of delivery mechanisms including, but not limited to, IP streaming or DVB-ASI. According to one embodiment, the media server 530 is instructed how to proceed by receiving a playlist 552 from the VoD server 550. As previously discussed, the playlist 552 includes the content and preferably the ads that should be displayed to the subscriber. The playlist 552 likely points to the locations in the ad database 570 and VoD content database 580 that the content 574, 584 can be located. Alternatively, the media server 530 may be instructed by the receipt of triggers that instruct the media server 530 what to do one step at a time. That is, a first trigger may instruct the media server 530 to play ad #1, and a second trigger may instruct the media server 530 to play the selected video. The triggers may be transmitted from the VoD server 550 or alternatively maybe transmitted from the STB 510 (in the embodiment where the STB 510 receives the playlist 552). As one skilled in the art would recognize, if triggers are used then either the VoD server 550 or the STB 510 depending on which embodiment is implemented need to monitor the media server 530 so that it can send the next trigger at the appropriate time.

The STB 510 may actually be a PVR and at least some targeted ads will be spooled off of the PVR 510. According to one embodiment, the playlist 552 is sent to the PVR 510 and the PVR 510 generates the triggers for the VoD content and any ads that were not stored thereon. Alternatively, the media server 530 may receive the playlist 552 and according stream all of the media to the PVR 510, and the PVR 510 substitutes some of the ads that it determines should be substituted (whether the delivered ads are default or targeted). The concepts associated with the subscriber having a PVR are discussed in more detail later.

Download Carousel 525

The download carousel 525 delivers files to the STB 510 including a channel map, program data (EPG data), and VoD content list 582. In some embodiments, the download carousel 525 may deliver ad metadata, ad queues, and possibly ads to the STB. The downloading of channel maps and EPG data is known to those skilled in art. The VOD content list 582 downloaded to the STB 510 may be a listing of the entire contents of the VoD content database 580 or may be a subset thereof. The VoD content list 582 may also include cost models, pricing, etc. According to one embodiment, the VoD content list 582 is downloaded and stored on the STB 510. Updates to the VoD content list are transmitted when required. Alternatively, the VoD content list 582 (or portions thereof) are transmitted to the subscriber as the subscriber navigates through the available content.

The VOD content list 582 contains one record for each item that can be purchased by the subscriber. The VoD content list 582 includes information about the content in addition to listing the available content. The information may be provided for both presentation to the subscriber and for managing the VoD selection process. Information important to the subscriber may include, but is not limited to, the program title, episode title, release date, description, cost, MPAA rating, and duration. Information important to managing the VoD selection process may include, but is not limited to, the content ID, ads that may be associated with the content, cost models, and access privileges.

The associated ads portion of the VoD content list 582 may indicate ads that can, are preferred, or are required to be played, or ads that cannot, are disfavored, or are banned from being played in conjunction with the VoD content. For example, for the movie “Mission Impossible” ads for Pepsi and McDonalds may be played, ads for Ford and Burger King are preferred (i.e., premium fees for placement), while ads for BMW are required (i.e., advertiser paid fee to have their ad played every time this content is selected). Conversely, ads for Coke may not be played, ads for Chevy are disfavored (will pay minimum fee) and ads for Mercedes are banned (i.e., may be part of license with BMW that no Mercedes ads are played).

The advertisers (or media buyers) may select their advertising campaign for VoD based on the content title, content genre, actors in the content, time viewed, number of times this subscriber/household has previously viewed these ads, or other methods that would be obvious to one of skill in the art. For example, Coke may identify that they would like to place ads in all “I Love Lucy” episodes unless the subscriber/household has previously been provided with more than a certain number of Coke ads (i.e., 5) in a certain time frame (i.e., the last four hours). The determination of how many times a subscriber/household has previously viewed a particular ad will be discussed in more detail later. In a preferred embodiment, the ads will also be selected so that they are targeted to the household in some fashion. For example, Pepsi may identify that their ads can be placed in all action movies but place a premium for placing ads in action movies where the subscribers are identified as having families of four. The targeting of ads will be discussed in more detail later.

In embodiments where the STB 510 has profiling capability as previously discussed, the ad metadata 572 is transmitted to the STB 510. The ad metadata 572 may be transmitted at fixed intervals, when all the ads defined in the ad metadata have been played and accordingly need to be replenished, for each VoD request or other methods that would be known to those of ordinary skill in the art. The ad metadata 572 for all the available ads may be transmitted or a portion thereof. The ads available for each specific VoD request 512 may be different as certain ads can and cannot be played with certain content (previously discussed). If the ad meta data 572 for all ads that are potentially available for each VoD request (complete list of ads capable of being selected) is to be transmitted to the STB 510 for the STB to compare to the subscriber profiles, the STB 510 likely will need to be a PVR as memory would be required to store the meta data 572 for the complete set of ads.

For ad queues and ads to be stored at the subscriber side 500, the STB 510 would need to be a PVR 510. The ads and ad queues can be delivered via the download carousel 525 at set intervals, when required, or other means that would be obvious to one of ordinary skill in the art. The ads may be downloaded over an ad channel, via a separate connection, such as an Internet connection, or other means that would also be obvious to those of ordinary skill in the art.

As previously discussed, ads (preferably targeted) may be pre-pended, post pended or inserted within the on demand content. Pre-pending and post-pending ads requires nothing more then to generate a playlist that includes the ads before the content and ads after the content (see FIG. 6). If ads are to be inserted within the content, ad opportunities (avails) need to be defined. According to a preferred embodiment, the content that ads are inserted within is content that was developed to have ads inserted therein (i.e., syndicated programming or made for TV movies). This type of programming may or may not have the avails identified. If defined, the avails may be defined with cue tones, digital cue messages or fade to blacks. If the avails are not defined, the content provider, network operator, or third party may have to re-encode the programming so that it has avails.

A simple playlist 552 lists the content that should be played in the correct order and where to find the content. As such, a simple playlist 552 would not be able to be used to instruct the media server 530 as it could not easily define where and when the ads were inserted. That is, during the playback of the content, ads need to be inserted upon the detection of cue tomes, fade to blacks, etc. Thus, either the media server 530 has to be capable of detecting and handling these events or the VoD server 550 or STB 510 need to monitor the media server 530 and send triggers when the appropriate avails are found.

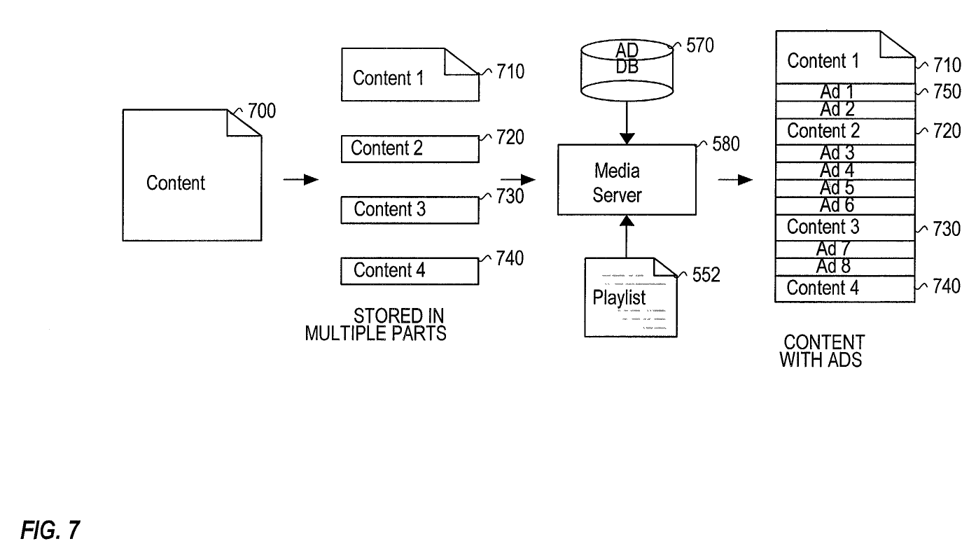

In a preferred embodiment, when the VoD content is encoded it is encoded into several segments. FIG. 7 illustrates an exemplary encoding of content into multiple parts so that ads can be inserted therewithin. As illustrated the content 700 is broken into 4 distinct part 710, 720, 730, 740 and each of these parts is stored in the VoD content database 580. Once, the VoD server generates the playlist 552, the media server 530 selects the appropriate content 710-740 and the appropriate ads 750 from the ad database 570 so that the content can be delivered to the subscriber with ads. As illustrated several ads are inserted between the different segments of the content. According to this preferred embodiment, the system need not detect cue tones, etc in order top determine where the avail is and then insert the appropriate ad therein. Rather a single playlist is generated that includes that ads at the appropriate times.

If the subscriber has a PVR, the PVR can be used to assist in the targeting of ads. The PVR likely has an ad queue that defines which ads should be displayed in what order. The ads may also be stored on the PVR or may be stored on the network end 520. The ad queue may be a single ad queue that simply defines an order in which ads should be displayed in the available avails. Alternatively, the ad queue may be an adjustable ad queue that adjust s the order of the ads based on subscriber, content, time, avail size and other methods. There may be a single ad queue or there may be multiple ad queues that the PVR switches between. The ad queue may simply track standard ads (i.e., typical 30 or 60 second spots) or it may also track ads inserted in EPGs, banner ads, product placement ads, ad overlays, or bugs. The ad queue may coordinate the display of the various different type of ads to enhance the ad message while also being careful not to over saturate the subscriber.

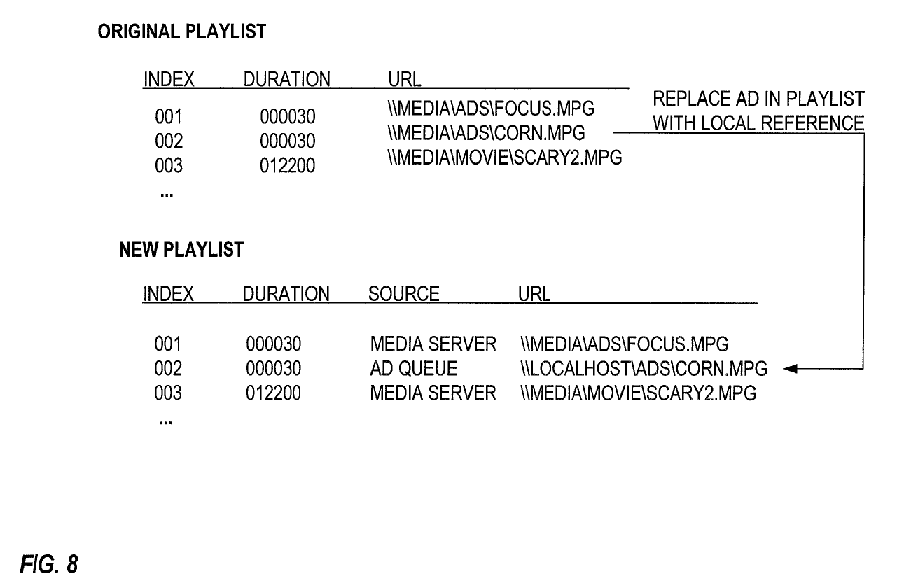

The ad queue may be used to override the ads that the network side has selected. For example, if the playlist calls for ad 1 to be pre-pended to the content and the ad queue determines that ad #1 is not the most applicable and that ad #2 is more applicable (for whatever reason) the PVR may overwrite the playlist to include the new ad. The easiest way for the PVR to overwrite the playlist is for the playlist to be sent to the PVR and the PVR direct the media server 530. If ads are stored on the PVR, the playlist may be overwritten to replace the location of the targeted ad from the ad database 570 to the local ad file on the PVR. FIG. 8 illustrates an exemplary embodiment of an original playlist be modified to account for the fact that one of the ads was local.

Alternatively, the ad queue may not modify the playlist at all. The media server can deliver the selected ads to the PVR and if the ad queue determines that a local ad is more applicable the PVR can insert the local ad in place of the ad that was sent from the content provider (regardless of whether that ad was targeted or not). In this embodiment, the playlist need not be modified ahead of time as the substitution is done on the fly by the PVR. The PVR would have to inform the billing server 560 of the substitution so that the appropriate advertiser could be billed.

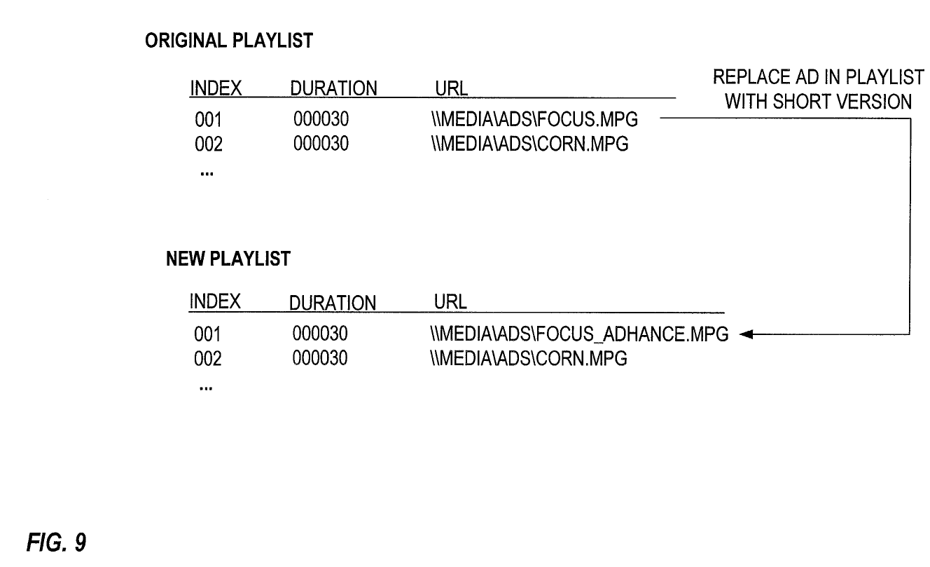

As previously discussed the VoD system may not enable the subscribers to fast forward or skip advertisements that are delivered with the VoD content. Alternatively, the subscriber may be presented with a short alternative ad when the subscriber attempts to fast forward or skip the advertisement (targeted or default) so that the advertiser maintains same value for their advertising dollar and the subscriber does not get offended by the lose of control. The alternative ad may be a section of the original ad, may be created from the original ad in some manner, or may be a separate ad altogether. There are numerous means for replacing the original ad (being fast forwarded) with the alternative ad. For example, when a fast forward command is received, the playlist may be modified so that the alternative ad is transmitted instead of the ad. FIG. 9 illustrates an exemplary embodiment in which the playlist is modified as such. The modification of the playlist can either be accomplished by the VoD server 550 or the STB 510 (or PVR). In the PVR embodiment, the alternative ad may be contained on the PVR in which case the playlist will be modified to reflect that (regardless of whether the ad was on the PVR or the network)

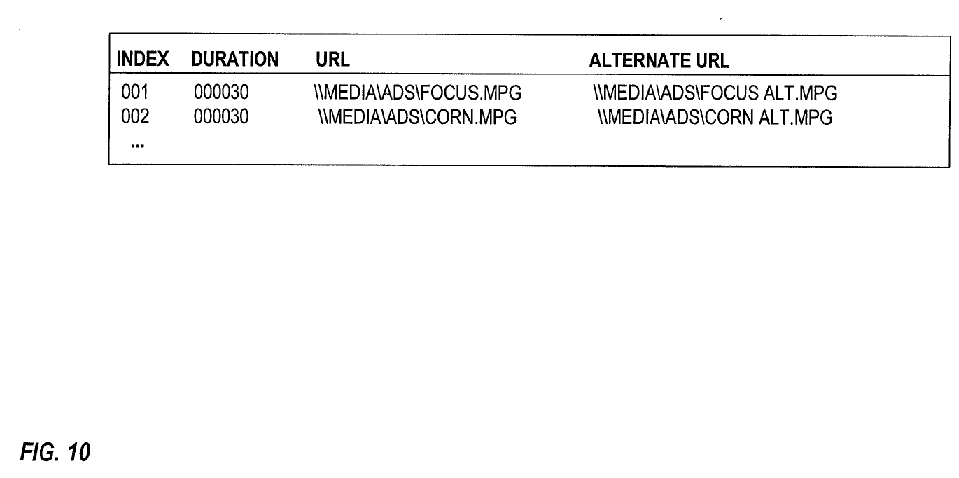

According to another embodiment, the playlist may include an alternative ad therein as illustrated in FIG. 10. When the fast forward command is detected during playing of the ad, the playlist switches to displaying the alternative ad. This embodiment requires a media server 530 that is capable of handling alternative ad presentations (URL as illustrated). The alternative ad location may be placed in the playlist when the playlist is created by the VoD server or may be added at a later time either by the VoD server 530 or the STB 510 (or PVR). In the PVR embodiment, the alternative ad may be contained on the PVR in which case the playlist will be modified to ad that as the location of the alternative ad (regardless of whether the ad is stored on the PVR or the network)

According to another embodiment, the ad metadata includes instructions (processing rules) about how to modify the ad to create the alternative ad. When the fast forward or skip command is initiated the system modifies the ad on the fly according to the instructions and presents the alternative ad just created to the subscriber. This embodiment may be performed by the network side or by the PVR. It should be noted that the alternative ads that are stored on the network side or the PVR may have been created by the network or PVR respectively prior to being saved. Alternatively, the producer of the ad may have created the alternative ad at the time they created the ad and provided both ads to the ad server and possibly the PVR.

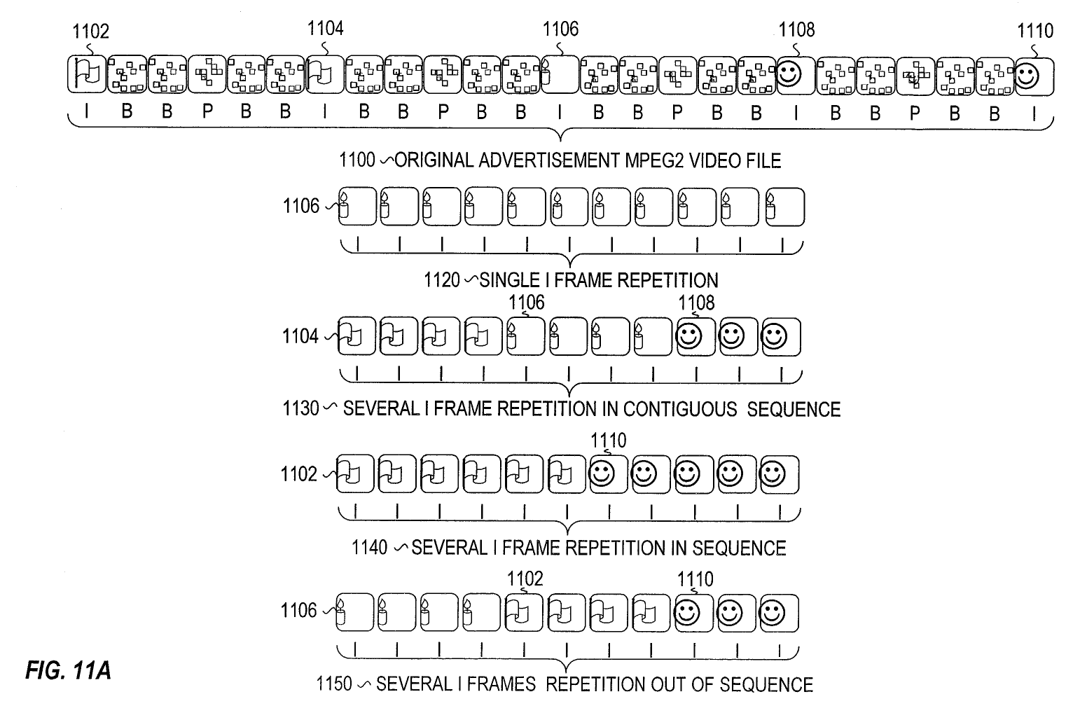

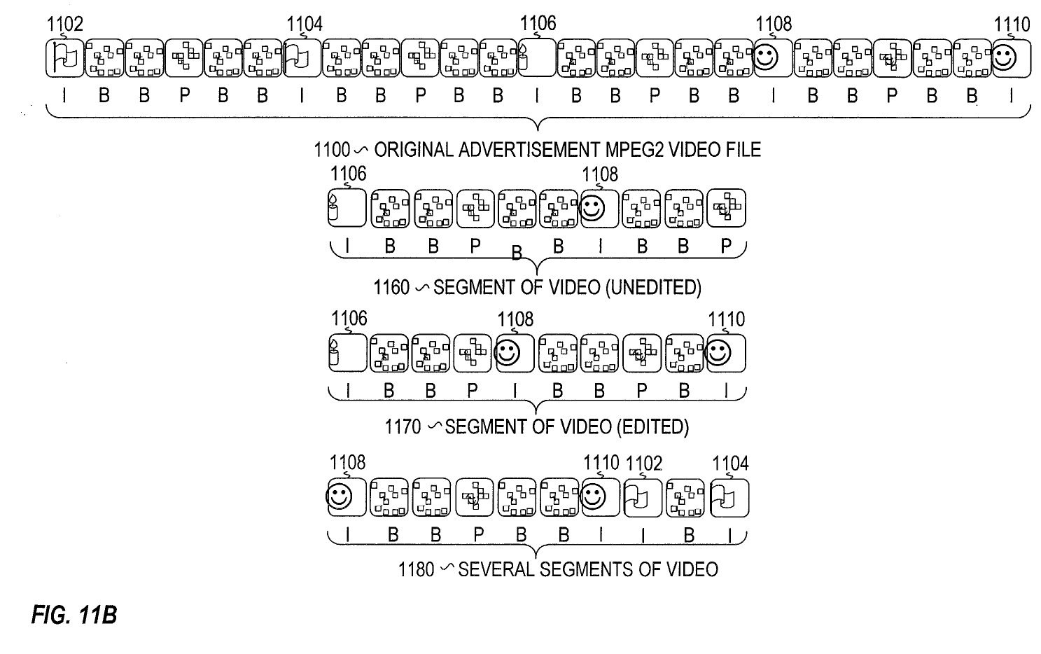

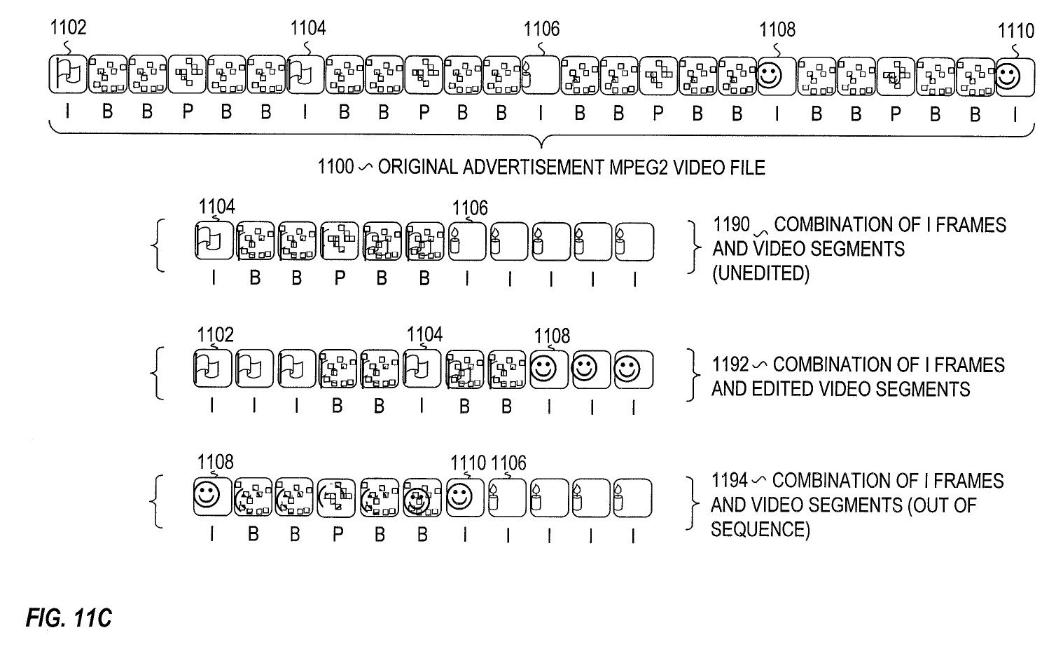

FIGS. 11A-C illustrate an exemplary advertisement in MPEG format and several exemplary alternative advertisements that can be created therefrom. As illustrated, the exemplary advertisement 1100 has an I-frame every 6^{th} frame. That is, the 1^{st} I frame is the 1^{st} frame 1102, the second I frame is the 7^{th} frame 1104, the 3^{rd} I frame is the 13^{th} frame 1106, the 4^{th} I frame is the 19^{th} frame 1108, and the 5^{th} I frame is the 25^{th} frame 1110. The processing rules used to generate the alternative ads may have been specific to the advertisement 1100 or general in nature, and the advertisement 1100 may be flagged in some fashion or not. An important aspect of the processing rules as shown in the exemplary alternative advertisements in FIGS. 11A-C, is the preservation of inter-frame coding relationships. That is, a predicted frame (ether P-frame or B-frame in the MPEG-2 examples) must be accompanied by the necessary anchor frames (I or P frames used to predict the inter-frame coded picture).

FIG. 11A illustrates exemplary alternative advertisements made up of only I-frames. A first exemplary alternative advertisement 1120 is a single I frame for the entire time it takes to fast forward through the advertisement. As illustrated, frame 1106 was selected to display. A second exemplary alternative advertisement 1130 is several contiguous and sequential I-frames being displayed. As illustrated, the 2^{nd} I-frame (7^{th} frame) 1104, the 3^{rd} I frame (13^{th} frame) 1106, and the 4^{th} I-frame (19^{th} frame) 1108 are displayed one after another. A third exemplary alternative advertisement 1140 is several sequential I-frames being displayed. As illustrated, the 1st I-frame (1st frame) 1102, and the 5^{th} I-frame (25^{th} frame) 1110 are displayed one after another. A fourth exemplary alternative advertisement 1150 is several I-frames being displayed out of sequence. As illustrated, the 3rd I-frame (13^{th} frame) 1106, the first I-frame (1^{st} frame) 1102, and the 5^{th} I-frame (25^{th} frame) 1110 are displayed one after another. As one skilled in the art would recognize, there are numerous combinations of displaying single images one after another that would be well within the scope of the current invention.

FIG. 11B illustrates exemplary alternative advertisements made up of segments of video from the original advertisement 1100. A first exemplary alternative advertisement 1160 is a single segment of video extracted unedited from the advertisement 1100. As illustrated, the video from the 3^{rd} I-frame 1106 through the fourth I-frame 1108 and continuing to the 1st P-frame thereafter makes up the alternative advertisement 1160. A second exemplary alternative advertisement 1170 is a single segment of video that is edited from the form of the advertisement 1100. As illustrated, the third I-frame 1106 is displayed followed by only limited B-frames thereafter, followed by the fourth I-frame 1108 and a majority of the B-frames and P-frames thereafter, followed by the fifth I-frame 1110. In this embodiment, the segment of video was similar to the unedited version 1160, except certain B-frames and P-frames were removed and additional video was displayed (I-frame 1110). A third exemplary alternative advertisement 1180 is several segments of video combined together (edited or unedited, in order or out of order). As illustrated, the entire video between I-frame 1106 and I frame 1108, is followed by an edited version of the video from I-frame 1102 to I-frame 1104. As one skilled in the art would recognize, there are numerous combinations of displaying segments of video that would be well within the scope of the current invention.

FIG. 11C illustrates exemplary alternative advertisements made up of a combination of segments of video and I-frames from the original advertisement 1100. A first exemplary alternative advertisement 1190 is a combination of a segment of unedited video and an I-frame.

As illustrated, the video from I-frame 1104 to I-frame 1106 is followed by the repetition of I-frame 1106. A second exemplary alternative advertisement 1192 is a combination of segments of edited video and I-frames. As illustrated, I-frame 1102 is repeated, followed by edited video from I-frame 1102 through I-frame 1104 and beyond, followed by repetition of I-frame 1108. A third exemplary alternative advertisement 1194 is a combination of segments of video and I-frames out of sequence. As illustrated, the video from I-frame 1108 to I-frame 1110 is followed by the repetition of I-frame 1106. As one skilled in the art would recognize, there are numerous iterations of displaying segments of video in combination with I-frames that would be well within the scope of the current invention.

The alternative ad may replace the fast forwarding ad (subscriber doesn't see fast forwarding ad at all) or it may be used in conjunction with the fast forwarding ad (the viewer sees both the fast forwarding ad and the alternative ad in some fashion). There are numerous methods for displaying both ads that would be well within the scope of the current invention, including, but not limited to, picture-in-picture, split screen, overlays, and computer graphics. The generation and placement of alternative ads is described in detail in applicants' co-pending application that have previously been incorporated and identified by docket numbers T738-00, T738-01 and T738-10.

According to another embodiment, there may be several different alternative versions of the ad and the appropriate ad is displayed based on the subscriber profile. That is, in this embodiment the alternative ads are targeted.

According to one embodiment, additional opportunities are available to advertise within the viewing of the on demand content including alternative type ads that are defined as advertisements that are not associated with the typical avails defined within the program stream (i.e., 30 second ad) but rather are associated with and incorporated into the programming. The alternative type advertisements include, but are not limited to, overlay advertisements, product placement advertisements and advertisement “bugs”. Overlay advertisements can be defined as advertisements that are inserted in available or blank space in the programming, such as on the wall of a sport arena. Product placement advertisements can be defined as products that are placed in the programming, such as an actor drinking a Pepsi. Advertisement “bugs” can be defined as an image that is overlaid on a portion of the screen, such as the network logos that are often displayed in the corner of the programming.

In order to place overlay and product placement advertisements, the system needs to be capable of determining the availability of overlay and product placement avails. According to one embodiment, the provider of the programming needs to identify these avails and include those details in the VoD content list. As these type of avails are likely unique for each program, it is likely that a separate ad (and possibly a plurality of targeted ads) are generated for each program. The ads may be targeted based on any number or combination of profiles previously discussed or other means that would be obvious to one of ordinary skill in the art. The alternative type ads may be inserted at the headend and thus the content received by the subscriber includes the alternative type ads.

Alternatively, the alternative type ads may be transmitted with the programming or separate therefrom and be matched up with the avails at the STB. In one embodiment multiple ads are sent for each avail, and the STB decides which one to insert based on a correlation of between an ad profile and the profile of the viewer. In an alternative embodiment, only advertisements that are associated with the viewer are transmitted to the STB for insertion therein.

In a PVR embodiment, the PVR may have numerous overlay and product placement advertisements stored thereon and insert the appropriate advertisement in the content when it is determined that a match exists. According to another embodiment, the PVR may have still images stored thereon and be able to modify the still images based on the definition of the avails and then insert the modified images in the overlay and/or product placement avails. In his embodiment, the generation and insertion of the overlay and product placement ads can be based on a queue stored within the PVR. There may be a single queue for each type of ad or there could be separate queues (one for overlay advertisements and one for product placement advertisements).

As one skilled in the art might recognize, the changing of product placement ads during the program is somewhat restricted. That is, it would not be acceptable for the drink an actor was drinking to change from Coke to Pepsi in the middle of a scene. However, it is quite possible that different product placements would occur throughout the viewing of a particular program. With respect to overlay and “bug” advertisements it is possible that the advertisement switches after a predetermined period of time. That is, the advertiser pays a certain amount to have a “bug” placed on the screen for a certain amount of time. As should also be obvious to those of ordinary skill in the art, the “bugs” are not program dependent where the overlay and product placement ads are program dependent.

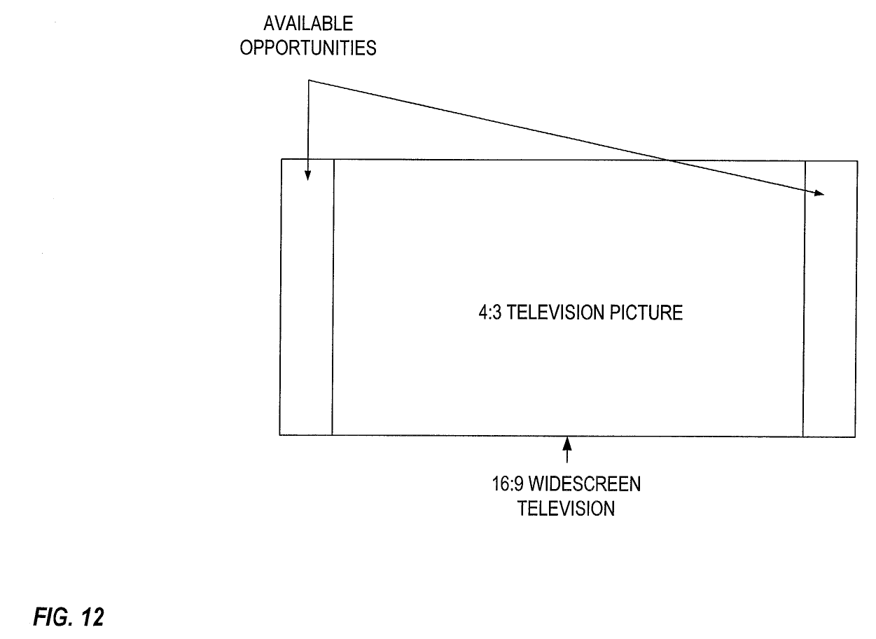

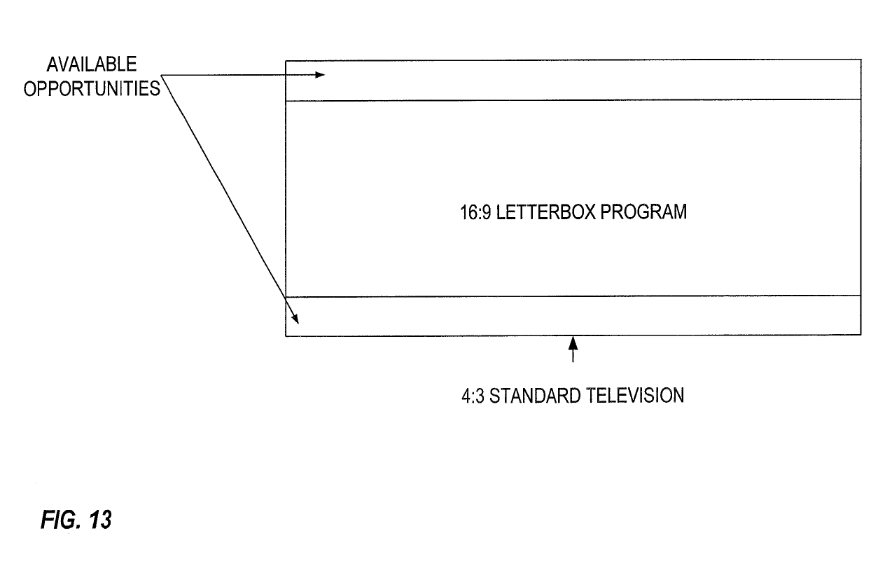

According to another embodiment, additional opportunities exist for targeting advertising. These opportunities are not limited to VoD but can also be used for standard video delivery (i.e., network or cable television). For example, the opportunity for the placement of ads exists during movie credits. A split-screen or picture-in-picture mechanism can be used to show the credits while displaying targeted advertising. The service provider would need to get approval from the content provider for delivering ads in this manner. Moreover, additional opportunities exist when the type of broadcasting and the display device are not in sync. For example, traditional broadcasting (4:3 resolution picture) viewed on a 16:9 resolution wide screen television does not use the entire screen (see FIG. 12). Likewise, letterbox movies that are viewed on a standard 4:3 resolution television also do not use the entire screen (see FIG. 13). The unused portion of the screens in each embodiment (FIGS. 11 and 12) can contain targeted advertising, such as banner ads.

In addition to video on demand, targeted ads can be prepended and postpended to pay per view on PVR-enabled set-top boxes. The subscriber tunes to a pay-per-view channel and chooses to buy the program. All programs include prepended and postpended ads and previews. During these prepended and postpended sequences, the PVR can insert targeted advertising. Viewers using set-top boxes without PVR capability receive the default advertising for the pay-per-view channel.

As previously discussed the insertion of targeted ads can be part of an over all ad campaign for a specific subscriber. In order to manage an overall ad campaign the system (either the headend or PVR) needs to be capable of maintaining a master ad queue or monitoring multiple different ad queues. The various ad queues, can include, but are not limited to, ad queues for standard advertisements, EPG/IPG advertisements, advertisements that are either prepended or post pended to recorded programming, product placement ads, overlay ads, and ad bugs. The coordination may be to not saturate the viewer with the same type of ads or may be to coordinate the ads so that the viewer is presented with ads for the same product or company in an organized fashion over multiple avails. For example, the user may see a Coke ad in the programming they are watching followed by a still image of a Coke can when they activate the EPG soon thereafter. As one skilled in the art would recognize, there are numerous methods f coordinating the various ad queues that would be well within the scope of the current invention.

As one of ordinary skill in the art would recognize, the above described functions can be implemented as a set of computer instructions stored on a computer readable medium. The present invention can be realized in a number of programming languages including C, C++, Per1, and Java, although the scope of the invention is not limited by the choice of a particular programming language or tool. Object oriented languages have several advantages in terms of construction of the software used to realize the present invention, although the present invention can be realized in procedural or other types of programming languages known to those skilled in the art.

Although this invention has been illustrated by reference to specific embodiments, it will be apparent to those skilled in the art that various changes and modifications may be made, which clearly fall within the scope of the invention. The invention is intended to be protected broadly within the spirit and scope of the appended claims.

What is claimed is:

1. A method for delivering targeted advertisements to a subscriber with video that the subscriber selected to receive from a video on demand system, the method comprising:
selecting the video;
determining available advertisement opportunities in the selected video;
receiving advertisement profiles, wherein the advertisement profiles define traits for an associated advertisement; and
traits for an intended target market of the associated advertisement, wherein the intended target market traits include presence or absence of specific transactions;
determining the advertisements available for delivery with the video by comparing the advertisement traits and the available advertisement opportunities;
searching associated subscriber transaction data for the presence or absence of the specific transactions defined in the intended target market traits;
selecting at least a subset of the targeted advertisements from the available advertisements based on said searching; and
delivering the selected video and the targeted advertisements to the subscriber.

2. The method of claim 1, wherein the specific transactions are kept confidential.

3. The method of claim 1, wherein the specific transactions are purchase transactions.

4. The method of claim 3, wherein the purchase transactions are maintained external to the video on demand system.

5. The method of claim 4, wherein said searching is performed external to the video on demand system.

6. The method of claim 3, wherein the purchase transactions are related to at least some subset of product type, products, brands, size, price, quantity, and time.

7. The method of claim 1, wherein the specific transactions are viewing transactions.

8. The method of claim 7, wherein the viewing transactions are maintained within a device located at a subscriber location.

9. The method of claim 8, wherein said searching is performed in the device.

10. The method of claim 7, wherein the viewing transactions are related to at least some subset of channel, network, program, genre, viewing duration, channel change frequency, and volume level.

11. The method of claim 1, wherein said searching is performed by a secure third party.

12. The method of claim 1, wherein the associated subscriber transaction data is stored in a single database.

13. The method of claim 1, wherein the associated subscriber transaction data is stored in multiple distributed databases.

14. The method of claim 1, wherein the intended target market traits further include transaction characteristics.

15. The method of claim 14, wherein the transaction characteristics are purchasing characteristics.

16. The method of claim 15, wherein the purchase characteristics define characteristics related to at least some subset of product type, products, brands, sizes, price, and quantity.

17. The method of claim 14, wherein the transaction characteristics are viewing characteristics.

18. The method of claim 17, wherein the viewing characteristics define characteristics related to at least some subset of channel, network, program, genre, viewing duration, channel change frequency, and volume level.

19. The method of claim 14, further comprising comparing transaction characteristics of the intended target market with transaction characteristics of the subscriber.

20. The method of claim 19, further comprising selecting at least a subset of the targeted advertisements from the available advertisements based on said comparing.

21. The method of claim 20, wherein said selecting at least a subset of the targeted advertisements from the available advertisements based on said comparing includes selecting the at least a subset of the targeted advertisements from the available advertisements based on said comparing and some combination of household demographics, the selected video, and previous video selections.

22. The method of claim 19, wherein said selecting at least a subset of the targeted advertisements includes selecting the at least a subset of the targeted advertisements based on said searching and said comparing.

23. The method of claim 22, wherein said selecting the at least a subset of the targeted advertisements from the available advertisements based on said searching and said comparing includes selecting the at least a subset of the targeted advertisements from the available advertisements based on said selecting, said comparing and some combination of household demographics, the selected video, and previous video selections.

24. The method of claim 1, wherein said selecting at least a subset of the targeted advertisements from the available advertisements based on said searching includes selecting the at least a subset of the targeted advertisements from the available advertisements based on said selecting and some combination of household demographics, the selected video, and previous video selections.

25. The method of claim 1,further comprising selecting at least a subset of the targeted advertisements from the available advertisements based household demographics, the selected video, previous video selections or some combination thereof.

26. The method of claim 1, wherein the advertisements traits include parameters defining limits on presentation of the associated advertisement to the subscriber, and further comprising
monitoring advertisements presented to the subscriber;
confirming that the selected targeted advertisements are within the limits defined in the advertisement traits based on said monitoring.

27. The method of claim 1, wherein the available advertisement opportunities may be prior to, during, within or after the video.

28. The method of claim 27, wherein said delivering includes delivering the targeted advertisements prepended to the video if the advertisement opportunities are prior to the video.

29. The method of claim 27, wherein said delivering includes delivering the targeted advertisements postpended to the video if the advertisement opportunities are after the video.

30. The method of claim 27, wherein said delivering includes delivering the targeted advertisements between different segments of the video if the advertisement opportunities are during the video.

31. The method of claim 27, wherein said delivering includes delivering the targeted advertisements as part of the video if the advertisement opportunities are within the video.

32. The method of claim 31, wherein the advertisement opportunities within the video include at least some subset of bugs, product placements, overlays, and banners.

33. A video on demand system for delivering targeted advertisements to a subscriber with video selected by the subscriber, the method comprising:
a user interface for selecting the video;
means for determining available advertisement opportunities in the selected video;
means for receiving advertisement profiles, wherein the advertisement profiles define traits for an associated advertisement; and
traits for an intended target market of the associated advertisement, wherein the intended target market traits include presence or absence of specific transactions;
means for determining the advertisements available for delivery with the video by comparing the advertisement traits and the available advertisement opportunities;
means for searching associated subscriber transaction data for the presence or absence of the specific transactions defined in the intended target market traits;
means for selecting the targeted advertisements from the available advertisements, wherein at least a subset of the targeted advertisements are selected based on results from said means for searching; and
a delivery network for delivering the selected video and the targeted advertisements to the subscriber.

34. The system of claim 33, wherein said user interface is an EPG.

35. The system of claim 33, wherein the subscriber transaction data is maintained by a third party and said means for searching is an interface to the third party.

36. The system of claim 33, wherein the subscriber transaction data is maintained within a device located at a subscriber location.

37. The system of claim 36, wherein said means for searching is located within the device.

38. The system of claim 37, wherein said means for selecting is located within the device.

39. The system of claim 33, further comprising a database for storing subscriber transaction data.

40. The system of claim 33, further comprising distributed databases for storing subscriber transaction data.

41. The system of claim 33, wherein the intended market traits include viewing characteristics, and further comprising means for comparing the viewing characteristics of the intended target market with the viewing characteristics of the subscriber.

42. The system of claim 41, wherein said means for selecting the targeted advertisements selects at least a subset of the targeted advertisements based on results from said means for comparing.

43. The system of claim 41, further comprising means for generating the viewing characteristics of the subscriber.

44. The system of claim 43, wherein said means for generating includes
means for monitoring subscriber viewing interactions;
storage for storing a plurality of subscriber signatures, wherein the subscriber signatures identify traits about the subscriber including viewing characteristics and each subscriber signature is associated with unique subscriber traits;
means for comparing the subscriber viewing interactions with the subscriber signatures; and
means for associating the subscriber with the subscriber signature responsive to said means for comparing.

45. A computer program embodied on a computer-readable medium for selecting targeted advertisements to deliver to a subscriber with video selected by the subscriber, the computer program comprising:
a source code segment for receiving a request for the video;
a source code segment for determining available advertisement opportunities in the selected video;
a source code segment for receiving advertisement profiles, wherein the advertisement profiles define advertisement traits and intended target market traits;
a source code segment for determining the advertisements available for delivery with the video by comparing the advertisement traits and the available advertisement opportunities;
a source code segment for searching subscriber transaction histories for the presence or absence of specific transactions defined in the intended target market traits;
a source code segment for selecting the targeted advertisements from the available advertisements, wherein at least a subset of the targeted advertisements are selected responsive to said source code segment for searching; and
a source code segment for delivering the selected video and the targeted advertisements to the subscriber.

46. The computer program of claim 45, further comprising a source code segment for comparing viewing characteristics defined in the intended target market traits with subscriber viewing characteristics.

47. The computer program of claim 45, wherein said source code segment for selecting the targeted advertisements selects at least a subset of the targeted advertisements responsive to said source code segment for comparing.

48. The computer program of claim 45, further comprising a source code segment for generating the subscriber viewing characteristics.

49. The computer program of claim 48, wherein said source code segment for generating includes
a source code segment for monitoring subscriber viewing interactions;
a source code segment for comparing the subscriber viewing interactions with a plurality of subscriber signatures, wherein the subscriber signatures identify traits about the subscriber including viewing characteristics and each subscriber signature is associated with unique subscriber traits; and
a source code segment for associating the subscriber with a subscriber signature responsive to said source code segment for comparing.

50. A method for delivering targeted advertisements to a subscriber along with video that the subscriber selected to receive from a delivery network, the method comprising:
selecting the video;
determining available advertisement opportunities in the video;
receiving advertisement profiles, wherein each advertisement profile defines traits for an associated advertisement; and
traits for an intended target market of the associated advertisement, wherein the intended target market traits include viewing characteristics for the subscriber;
determining the advertisements available for delivery with the video by comparing the advertisement traits and the available advertisement opportunities;
monitoring subscriber viewing interactions;
comparing the subscriber viewing interactions to a plurality of subscriber signatures, wherein the subscriber signatures identify traits about the subscriber including viewing characteristics and each subscriber signature is associated with unique subscriber traits;
associating the subscriber with a subscriber signature based on said comparing the subscriber viewing interactions to a plurality of subscriber signatures;
comparing the intended target market traits to the selected subscriber signature;
selecting at least a subset of the targeted advertisements from the available advertisements based on said comparing the intended target market traits to the selected subscriber signature; and
delivering the video and the targeted advertisements to the subscriber.

51. The method of claim 50, wherein the viewing characteristics include at least some subset of favorite channels, favorite networks, favorite programs, favorite genre, viewing duration, channel change frequency, holding factor, and volume level.

52. The method of claim 50, wherein the viewing characteristics are broken out by day or day part.

53. The method of claim 50, wherein the subscriber signature further includes demographic traits for the subscriber.

54. The method of claim 50, wherein said monitoring, said comparing the subscriber viewing interactions to a plurality of subscriber signatures, and said associating are performed within a device located at a subscriber location.

55. The method of claim 54, wherein the device is a set top box or a personal video recorder.

56. The method of claim 54, wherein said comparing the intended target market traits to the selected subscriber signature and said selecting are performed within a device located at a subscriber location.

57. The method of claim 50, wherein the subscriber signatures are stored within a device located at a subscriber location.

58. The method of claim 50, further comprising generating the subscriber signatures by characterizing subscriber viewing interactions for each viewing session and clustering sessions having similar viewing characteristics together.

59. The method of claim 58, wherein said generating is performed within a device located at a subscriber location.

60. The method of claim 50, wherein the intended target market traits further include presence or absence of specific transactions.

61. The method of claim 60, wherein the specific transactions are purchase transactions.

62. The method of claim 61, wherein the purchase transactions are related to at least some subset of product type, products, brands, size, price, quantity, and time.

63. The method of claim 60, wherein the specific transactions are viewing transactions.

64. The method of claim 63, wherein the viewing transactions are related to at least some subset of channel, network, program, genre, viewing duration, channel change frequency, and volume level.

65. The method of claim 60, further comprising searching associated subscriber transaction data for the presence or absence of the specific transactions defined in the intended target market traits.

66. The method of claim 65, further comprising selecting at least a subset of the targeted advertisements from the available advertisements based on said searching.

67. The method of claim 66, wherein said selecting at least a subset of the targeted advertisements from the available advertisements based on said searching includes selecting the at least a subset of the targeted advertisements from the available advertisements based on said searching and some combination of household demographics, the selected video, and previous video selections.

68. The method of claim 65, wherein said selecting at least a subset of the targeted advertisements based on said comparing the intended target market traits to the selected subscriber signature includes selecting the at least a subset of the targeted advertisements based on said searching and said comparing the intended target market traits to the selected subscriber signature.

69. The method of claim 68, wherein said selecting the at least a subset of the targeted advertisements from the available advertisements based on said searching and said comparing the intended target market traits to the selected subscriber signature includes selecting the at least a subset of the targeted advertisements from the available advertisements based on said selecting, said comparing the intended target market traits to the selected subscriber signature, and some combination of household demographics, the selected video, and previous video selections.

70. The method of claim 50, wherein said selecting at least a subset of the targeted advertisements from the available advertisements based on said comparing the intended target market traits to the selected subscriber signature includes selecting the at least a subset of the targeted advertisements from the available advertisements based on said comparing the intended target market traits to the selected subscriber signature and some combination of household demographics, the selected video, and previous video selections.

71. The method of claim 50, further comprising selecting at least a subset of the targeted advertisements from the available advertisements based on household demographics, the selected video, previous video selections or some combination thereof.

72. The method of claim 50, wherein the advertisement traits include parameters defining limits on presentation of the associated advertisement to the subscriber, and further comprising
monitoring advertisements presented to the subscriber;
confirming that the selected targeted advertisements are within the limits defined in the advertisement traits based on said monitoring.

73. The method of claim 50, further comprising presenting the requested video and targeted advertisements to the subscriber on a viewing device.

74. The method of claim 73, wherein said presenting includes not permitting the targeted advertisements to be fast-forwarded or skipped.

75. The method of claim 73, wherein said presenting includes presenting an alternative advertisement when the subscriber fast-forwards or skips the targeted advertisement.

76. The method of claim 75, wherein the alternative advertisement is presented in place of the targeted advertisement.

77. The method of claim 75, wherein the alternative advertisement is presented in conjunction with the targeted advertisement.

78. A video on demand system for delivering targeted advertisements to a subscriber with video selected by the subscriber, the method comprising:
a user interface for selecting the video;
means for determining available advertisement opportunities in the video;
means for receiving advertisement profiles, wherein each advertisement profile defines traits for an associated advertisement; and
traits for an intended target market of the associated advertisement, wherein the intended target market traits include viewing characteristics for the subscriber;
means for determining the advertisements available for delivery with the video by comparing the advertisement traits and the available advertisement opportunities;
means for monitoring subscriber viewing interactions;
means for comparing the subscriber viewing interactions to a plurality of subscriber signatures, wherein the subscriber signatures identify traits about the subscriber including viewing characteristics and each subscriber signature is associated with unique subscriber traits;
means for associating the subscriber with a subscriber signature responsive to said means for comparing the subscriber viewing interactions to a plurality of subscriber signatures;
means for comparing the intended target market traits to the selected subscriber signature;
means for selecting the targeted advertisements from the available advertisements, wherein at least a subset of the targeted advertisements are selected responsive to said means for comparing the intended target market traits to the selected subscriber signature; and
a delivery network for delivering the video and the targeted advertisements to the subscriber.

79. The system of claim 78, wherein said means for monitoring, said means for comparing the subscriber viewing interactions to a plurality of subscriber signatures, and said means associating are located within a subscriber location device.

80. The system of claim 79, wherein the subscriber location device is a set top box or a personal video recorder.

81. The system of claim 79, wherein said means for comparing the intended target market traits to the selected subscriber signature and said means for selecting are performed within a subscriber location device.

82. The system of claim 78, wherein the subscriber signatures are stored within a subscriber location device.

83. The system of claim 78, further comprising means for generating the subscriber signatures by characterizing subscriber viewing interactions for each viewing session and clustering sessions having similar viewing characteristics together.

84. The system of claim 83, wherein said generating is performed within a subscriber location device.

85. The system of claim 78, further comprising means for searching subscriber transaction histories for the presence or absence of specific transactions defined in the intended target market traits.

86. The system of claim 85, further comprising selecting at least a subset of the targeted advertisements from the available advertisements based on said searching.

87. The system of claim 78, wherein the advertisements traits include parameters defining limits on presentation of the associated advertisement to the subscriber, and further comprising
means for monitoring advertisements presented to the subscriber;
means for confirming that the selected targeted advertisements are within the limits defined in the advertisement

88. A computer program embodied on a computer-readable medium for selecting targeted advertisements to deliver to a subscriber with video selected by the subscriber, the computer program comprising:
a source code segment for receiving selections for the video;
a source code segment for receiving advertisement profiles, wherein each advertisement profile defines traits for an intended target market of the associated advertisement, wherein the intended target market traits include viewing characteristics for the subscriber;
a source code segment for monitoring subscriber viewing interactions;
a source code segment for comparing the subscriber viewing interactions to a plurality of subscriber signatures, wherein the subscriber signatures identify traits about the subscriber including viewing characteristics and each subscriber signature is associated with unique subscriber traits;
a source code segment for associating the subscriber with a subscriber signature responsive to said source code segment for comparing the subscriber viewing interactions to a plurality of subscriber signatures;
a source code segment for comparing the intended target market traits to the selected subscriber signature;
a source code segment for selecting the targeted advertisements, wherein at least a subset of the targeted advertisements are selected responsive to said source code segment for comparing the intended target market traits to the selected subscriber signature; and
a source code segment for delivering the video and the targeted advertisements to the subscriber.

89. The computer program of claim 88, further comprising a source code segment for generating the subscriber signatures by characterizing subscriber viewing interactions for each viewing session and clustering sessions having similar viewing characteristics together.

90. A method for delivering targeted advertisements to a subscriber with video that the subscriber selected to receive from a video on demand system, the method comprising:
selecting the video;
determining available advertisement opportunities in the selected video;
receiving advertisement profiles, wherein the advertisement profiles define traits for an associated advertisement; and
traits for an intended target market of the associated advertisement;
determining the advertisements available for delivery with the video by comparing the advertisement traits and the available advertisement opportunities;
selecting the targeted advertisements from the available advertisements by comparing the intended market traits to some combination of a subscriber profile that defines traits associated with the subscriber, traits associated with the selected video, household demographics, or traits associated with previously selected videos;
delivering the selected video and the targeted advertisements to the subscriber;
presenting the selected video and targeted advertisements to the subscriber on a viewing device, wherein said presenting includes presenting an alternative advertisement when the subscriber fast-forwards or skips the targeted advertisement.

91. The method of claim 90, wherein the advertisement traits include parameters defining limits on presentation of the associated advertisement to the subscriber, and further comprising
monitoring advertisements presented to the subscriber;
confirming that the selected targeted advertisements are within the limits defined in the advertisement traits based on said monitoring.

92. The method of claim 90, wherein the available advertisement opportunities may be prior to, during, within or after the video.

93. The method of claim 92, wherein said delivering includes delivering the targeted advertisements prepended to the video if the advertisement opportunities are prior to the video.

94. The method of claim 92, wherein said delivering includes delivering the targeted advertisements postpended to the video if the advertisement opportunities are after the video.

95. The method of claim 92, wherein said delivering includes delivering the targeted advertisements between different segments of the video if the advertisement opportunities are during the video.

96. The method of claim 92, wherein said delivering includes delivering the targeted advertisements as part of the video if the advertisement opportunities are within the video.

97. The method of claim 96, wherein the advertisement opportunities within the video include at least some subset of bugs, product placements, overlays, and banners.

98. The method of claim 90, wherein the alternative advertisement is presented in place of the targeted advertisement.

99. The method of claim 90, wherein the alternative advertisement is presented in conjunction with the targeted advertisement.

100. The method of claim 90, wherein the alternative advertisement is derived from the targeted advertisement by application of processing rules.

101. The method of claim 90, wherein the alternative advertisement is a separate advertisement related to the targeted advertisement.

102. A video on demand system for delivering targeted advertisements to a subscriber with video that the subscriber selected to receive, the system comprising:
means for selecting the video;
means for receiving advertisement profiles, wherein the advertisement profiles define traits for an intended target market of the associated advertisement;
means for selecting the targeted advertisements by comparing the intended market traits to some combination of a subscriber profile that defines traits associated with the subscriber, traits associated with the selected video, household demographics, or traits associated with previously selected videos;
means for delivering the selected video and the targeted advertisements to the subscriber;
means for presenting an alternative advertisement when the subscriber fast-forwards or skips the targeted advertisement.

103. The system of claim 102, wherein said means for presenting presents the alternative advertisement in place of the targeted advertisement.

104. The system of claim 102, wherein said means for presenting presents the alternative advertisement in conjunction with the targeted advertisement.

105. The system of claim 102, further comprising means for deriving the alternative advertisement from the targeted advertisement by application of processing rules.

106. A computer program embodied on a computer-readable medium for selecting targeted advertisements to deliver to a subscriber with video selected by the subscriber, the computer program comprising:
a source code segment for receiving selections for the video;
a source code segment for receiving advertisement profiles, wherein the advertisement profiles define traits for an intended target market of the associated advertisement;
a source code segment for selecting the targeted advertisements by comparing the intended market traits to some combination of a subscriber profile that defines traits associated with the subscriber, traits associated with the selected video, household demographics, or traits associated with previously selected videos;
a source code segment for delivering the selected video and the targeted advertisements to the subscriber;
a source code segment for presenting an alternative advertisement when the subscriber fast-forwards or skips the targeted advertisement.

107. The computer program of claim 106, further comprising a source code segment for deriving the alternative advertisement from the targeted advertisement by application of processing rules.
